(19) United States
(12) Patent Application Publication
(10) Pub. No.: US 2026/0301059 A1
(43) Pub. Date: Oct. 1, 2026

(54) INFORMATION PROCESSING SYSTEM AND INFORMATION PROCESSING METHOD

(71) Applicant: SEIKO EPSON CORPORATION, Tokyo (JP)

(72) Inventor: Masanori KOIZUMI, Suwa (JP)

(21) Appl. No.: 19/576,030

(22) Filed: Mar. 24, 2026

(30) Foreign Application Priority Data
Mar. 26, 2025 (JP) 2025-052400

(51) Int. Cl. G06Q 30/0601; G06Q 10/0639; G06V 10/764

(52) U.S. Cl. CPC G06Q 30/0641; G06Q 10/06393; G06V 10/764

(57) ABSTRACT

An information processing system includes an acquisition section that acquires, from a terminal device capturing an object associated with a target product, imaging information, an identification section that specifies a characteristic of the target product based on the imaging information, a estimation section that estimates an environmental load applied to an environment by the target product based on a result of the specifying of the identification section, and a presentation section that presents the result on the terminal device. When the user of the terminal device inputs a correction of the specifying result of the identification section to the terminal device, the result of the specifying of the characteristic of the target product and a result of the estimation of the environmental load applied to the environment by the target product corrected based on the correction of the specifying result of the identification section.

The present application is based on, and claims priority from JP Application Serial Number 2025-052400, filed Mar. 26, 2025, the disclosure of which is hereby incorporated by reference herein in its entirety.

### BACKGROUND

### 1. Technical Field

The present disclosure relates to an information processing system and an information processing method.

### 2. Related Art

On Sep. 25, 2015, the United Nations General Meeting adopted the 2030 Agenda for Sustainable Development, centered on 17 sustainable development goals, namely SDGs (Sustainable Development Goals). Along with this, in recent years, it has become common to provide products in consideration of environmental load. For example, JP-A-2024-143481 discloses a technique relating to an ink injection apparatus which can contribute to the goal 12 “Ensure sustainable consumption and production patterns” in the SDGs and which has a small load on the environment.

However, in the related art, it is difficult for a user who considers purchasing a product to recognize the load of the product on the environment. Therefore, in the related art, there is room for improvement from the viewpoint of environmental protection from the user's perspective.

### SUMMARY

According to an aspect of the present disclosure, an information processing system includes an acquisition section that acquires, from a terminal device capturing an associated object associated with a target product, imaging information indicating a result of the imaging, a product identification section that specifies a characteristic of the target product based on the imaging information, a load estimation section that estimates an environmental load applied to an environment by the target product based on a result of the specifying of the product identification section, and a presentation section that presents the result of the specifying of the product identification section and a result of the estimation of the load estimation section on the terminal device. When the user of the terminal device inputs a correction of the specifying result of the product identification section to the terminal device, the acquisition section acquires input information indicating content of the input performed by the user from the terminal device. When the acquisition section acquires the input information, the product identification section corrects the result of the specifying of the characteristic of the target product based on the input information. When the product identification section corrects the result of the specifying, the load estimation section corrects the result of the estimation of the environmental load applied to the environment by the target product based on the corrected specifying result.

According to another aspect of the present disclosure, an information processing method includes acquiring, from a terminal device capturing an associated object associated with a target product, imaging information indicating a result of the imaging, specifying a characteristic of the target product based on the imaging information, estimating an environmental load applied to an environment by the target product based on a result of the specifying, and presenting the result of the specifying and a result of the estimation on the terminal device. When the user of the terminal device inputs a correction of the specifying result to the terminal device, the acquiring acquires input information indicating content of the input performed by the user from the terminal device. When the acquiring acquires the input information, the specifying corrects the result of the specifying of the characteristic of the target product based on the input information. When the specifying corrects the result of the specifying, the estimating corrects the result of the estimation of the environmental load applied to the environment by the target product based on the corrected specifying result.

### BRIEF DESCRIPTION OF THE DRAWINGS

FIG. 1 is a diagram schematically illustrating an example of a configuration of an environmental load estimation system according to a first embodiment of the present disclosure.

FIG. 2 is a block diagram illustrating an example of a configuration of a terminal device.

FIG. 3 is a block diagram illustrating an example of a configuration of a server apparatus.

FIG. 4 is a diagram schematically illustrating an example of classification of a captured image.

FIG. 5 is a block diagram illustrating an example of a data structure of product characteristic information.

FIG. 6 is a block diagram illustrating an example of a data structure of environmental load information.

FIG. 7 is a block diagram illustrating an example of a data structure of terminal presentation information.

FIG. 8 is a diagram schematically illustrating an example of an environmental load presenting screen.

FIG. 9 is a diagram schematically illustrating an example of an environmental load comparison screen.

FIG. 10 is a flowchart illustrating an example of an operation of the server apparatus.

FIG. 11 is a diagram schematically illustrating an example of a data flow in the server apparatus.

FIG. 12 is a block diagram illustrating an example of a configuration of a server apparatus according to a modification 1.1 of the present disclosure.

FIG. 13 is a diagram schematically illustrating an example of a data flow in the server apparatus according to the modification 1.1 of the present disclosure.

FIG. 14 is a block diagram illustrating an example of a configuration of a server apparatus according to a modification 1.2 of the present disclosure.

FIG. 15 is a diagram schematically illustrating an example of a data flow in the server apparatus according to the modification 1.2 of the present disclosure.

FIG. 16 is a block diagram illustrating an example of arrangement of a server apparatus according to a second embodiment of the present disclosure.

FIG. 17 is a diagram schematically illustrating an example of an environmental load presenting screen according to the second embodiment of the present disclosure.

FIG. 18 is a flowchart illustrating an example of an operation of the server apparatus according to the second embodiment of the present disclosure.

FIG. 19 is a diagram schematically illustrating an example of a data flow in the server apparatus according to the second embodiment of the present disclosure.

FIG. 20 is a block diagram illustrating an example of a configuration of a server apparatus according to a modification 2.1 of the present disclosure.

FIG. 21 is a diagram schematically illustrating an example of a data flow in the server apparatus according to the modification 2.1 of the present disclosure.

FIG. 22 is a block diagram illustrating an example of a configuration of a server apparatus according to a modification 2.2 of the present disclosure.

FIG. 23 is a diagram schematically illustrating an example of a data flow in the server apparatus according to the modification 2.2 of the present disclosure.

### DESCRIPTION OF EMBODIMENTS

Hereinafter, embodiments of the present disclosure will be described with reference to the accompanying drawings. However, in each drawing, a dimension and a scale of each section are appropriately different from actual ones. In addition, since the embodiments described below are suitable specific examples of the present disclosure, the embodiments include various technically preferable limitations, but the scope of the present disclosure is not limited to the embodiments unless otherwise stated in the following description to particularly limit the present disclosure.

### A. First Embodiment

In a first embodiment, an environmental load estimation system Sys will be described as an example of an information processing system.

### A.1. Overview of Environmental Load Estimation System Sys

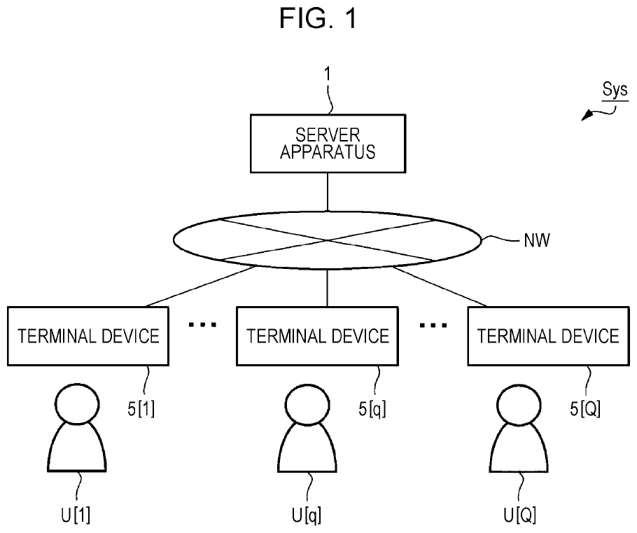

Hereinafter, an example of a configuration of the environmental load estimation system Sys according to the first embodiment will be described with reference to FIGS. 1 to 7. The environmental load estimation system Sys estimates a load applied to an environment by a product.

FIG. 1 is a block diagram illustrating an example of a configuration of the environmental load estimation system Sys.

As illustrated in FIG. 1, the environmental load estimation system Sys includes a server apparatus 1 and one or more terminal devices 5 capable of communicating with the server apparatus 1 via a network NW, and estimates a load applied to an environment by a product captured by the terminal device 5.

Hereinafter, as an example, it is assumed that the environmental load estimation system Sys includes Q terminal devices 5. Here, the value Q is a positive integer satisfying “Q≥1”. Hereinafter, a q-th terminal device 5 among the Q terminal devices 5 included in the environmental load estimation system Sys is referred to as a terminal device 5[q]. Here, the variable q is a positive integer satisfying “1≤q≤Q”. Hereinafter, a user U who uses the terminal device 5[q] is referred to as a user U[q].

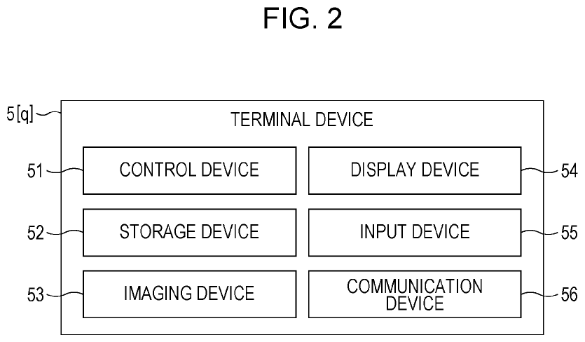

FIG. 2 is a block diagram illustrating an example of a configuration of the terminal device 5[q].

As illustrated in FIG. 2, the terminal device 5[q] includes a control device 51, a storage device 52, an imaging device 53, a display device 54, an input device 55, and a communication device 56.

The storage device 52 is a recording medium readable by the control device 51. The storage device 52 includes, for example, a volatile memory, such as a random access memory (RAM) that functions as a work area of the control device 51, and a nonvolatile memory, such as an electrically erasable programmable read-only memory (EEPROM) that stores various types of information, and stores a control program of the terminal device 5[q].

The control device 51 includes a processor. The processor included in the control device 51 includes, for example, one or more central processing units (CPUs). However, the processor included in the control device 51 may be configured to include hardware, such as a graphics processing unit (GPU), a digital signal processor (DSP), an application specific integrated circuit (ASIC), a programmable logic device (PLD), or a field programmable gate array (FPGA), in addition to one or more CPUs or instead of some or all of one or more CPUs. The processor included in the control device 51 executes a control program of the terminal device 5[q] stored in the storage device 52, and operates in accordance with the control program of the terminal device 5[q] to control individual sections of the terminal device 5[q].

The imaging device 53 is hardware for capturing an image of an object existing outside the terminal device 5[q] and for example, a camera can be adopted. When an image of an object outside the terminal device 5[q] is captured, the imaging device 53 outputs imaging information DG indicating a result of the image capturing. Here, the imaging information DG indicates a still image captured by the imaging device 53. However, the imaging information DG may indicate a moving image captured by the imaging device 53.

The display device 54 is hardware for displaying various types of information. As the display device 54, for example, various display panels, such as a liquid crystal display panel and an organic EL display panel, can be adopted.

The input device 55 is hardware for receiving an operation from the user U[q] of the terminal device 5[q]. In this embodiment, it is assumed that the display device 54 and the input device 55 are integrally configured. Specifically, in this embodiment, it is assumed that, for example, a touch panel is adopted as the display device 54 and the input device 55. However, the present disclosure is not limited to this aspect. As the input device 55, for example, a device, such as a keyboard or a mouse, or a combination of these devices may be adopted.

The communication device 56 is hardware for communicating with an external device existing outside the terminal device 5[q] via the network NW. In this embodiment, the control device 51 transmits various types of information to the server apparatus 1 via the communication device 56. Furthermore, the control device 51 acquires various types of information from the server apparatus 1 via the communication device 56.

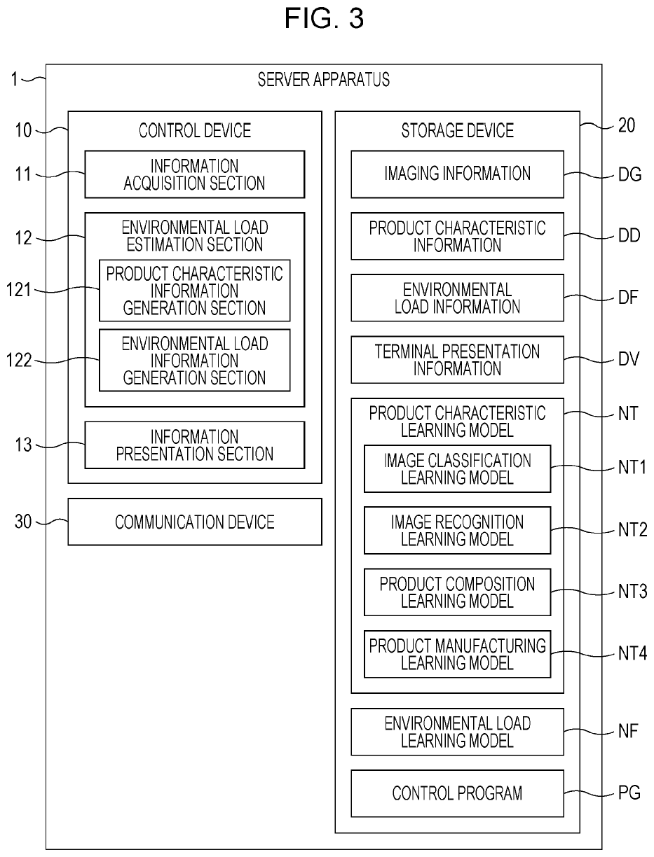

FIG. 3 is a block diagram illustrating an example of a configuration of the server apparatus 1.

As illustrated in FIG. 3, the server apparatus 1 includes a control device 10, a storage device 20, and a communication device 30.

The storage device 20 is a recording medium readable by the control device 10. The storage device 20 includes, for example, a volatile memory, such as a RAM that functions as a work area of the control device 10, and a nonvolatile memory, such as an EEPROM that stores various types of information, and stores imaging information DG, product characteristic information DD, environmental load information DF, terminal presentation information DV, a product characteristic learning model NT, an environmental load learning model NF, and a control program PG.

As described above, the imaging information DG indicates an image captured by the imaging device 53 (hereinafter, referred to as a “captured image GG”). In this embodiment, it is assumed that the user U[q] captures an image of a product-associated object SK using the imaging device 53 of the terminal device 5[q]. Here, the product-associated object SK is an object relating to a product SH whose environmental load is to be estimated by the environmental load estimation system Sys.

In this embodiment, as an example, it is assumed that the product-associated object SK is classified into one of the following seven classification items: a product main body SH1, a product package SH2, a product advertisement SH3, a product composition table SH4, a product content label SH5, a product manufacturing information table SH6, and a product barcode SH7.

Here, the product main body SH1 is a main body of the product SH. The product package SH2 is a package of the product SH. The product advertisement SH3 is an advertisement of the product SH on which an image of the product SH is displayed. The product composition table SH4 shows composition of constituent substances constituting the product SH. The product content label SH5 shows content of the product SH. The product manufacturing information table SH6 shows information on manufacturing of the product SH. The product barcode SH7 is a barcode of the product SH.

In this embodiment, it is assumed that the captured image GG is classified into a plurality of image types corresponding to classification of the product-associated object SK.

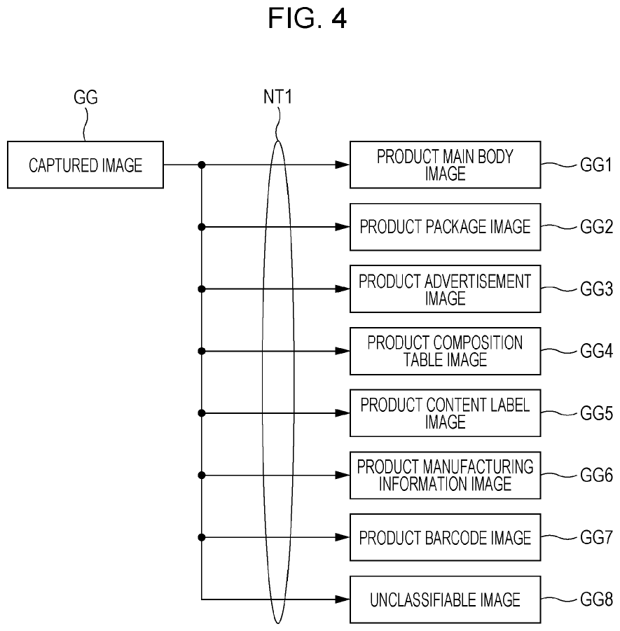

FIG. 4 is a diagram schematically illustrating an example of the classification of the captured image GG.

As illustrated in FIG. 4, in this embodiment, it is assumed that the captured image GG is classified into one image type of eight image types of a product main body image GG1, a product package image GG2, a product advertisement image GG3, a product composition table image GG4, a product content label image GG5, a product manufacturing information image GG6, a product barcode image GG7, and an unclassifiable image GG8 by an image classification learning model NT1 described later.

Here, the product main body image GG1 is a captured image GG indicating an imaging result of the product main body SH1. The product package image GG2 is a captured image GG indicating an imaging result of the product package SH2. The product advertisement image GG3 is a captured image GG indicating an imaging result of the product advertisement SH3. The product composition table image GG4 is a captured image GG indicating an imaging result of the product composition table SH4. The product content label image GG5 is a captured image GG indicating an imaging result of the product content label SH5. The product manufacturing information image GG6 is a captured image GG indicating an imaging result of the product manufacturing information table SH6. The product barcode image GG7 is a captured image GG indicating an imaging result of the product barcode SH7. The unclassifiable image GG8 is a captured image GG that is not classified into any of the seven image types from the product main body image GG1 to the product barcode image GG7.

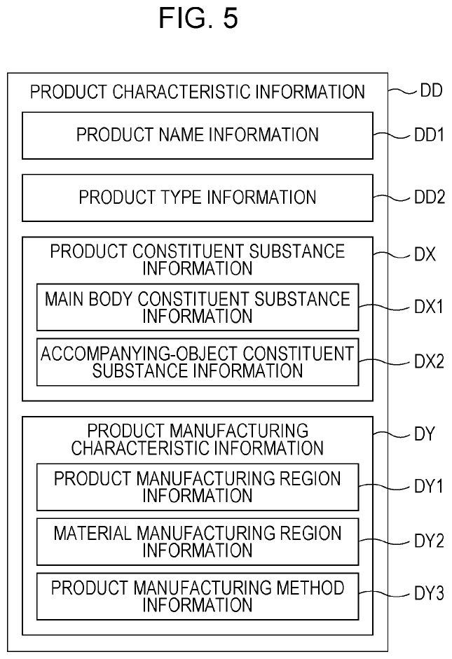

FIG. 5 is a block diagram illustrating an example of a data structure of the product characteristic information DD.

As illustrated in FIG. 5, in this embodiment, the product characteristic information DD includes product name information DD1, product type information DD2, product constituent substance information DX, and product manufacturing characteristic information DY.

The product name information DD1 indicates a name of the product SH whose environmental load is to be estimated by the environmental load estimation system Sys. In the following description, among products SH that can be captured by the terminal device 5[q], a product SH whose environmental load is to be estimated by the environmental load estimation system Sys may be referred to as a target product SHH.

The product type information DD2 indicates a type of the target product SHH.

The product constituent substance information DX includes main body constituent substance information DX1 and accompanying-object constituent substance information DX2.

The main body constituent substance information DX1 indicates material names of one or more substances constituting a main body portion of the target product SHH, and weights of the one or more substances.

Here, the main body portion of the target product SHH is a portion of an article to be sold as the target product SHH, excluding an accompanying object, and is a portion to be used in a case where the target product SHH is used in accordance with an intended use.

The accompanying object of the target product SHH is a portion that is not used when the target product SHH is used, and is an object accompanying the main body portion of the target product SHH. For example, a package of a main body portion of the target product SHH, a manual of the main body portion of the target product SHH, and the like can be exemplified as the accompanying object of the target product SHH.

The accompanying-object constituent substance information DX2 indicates material names of one or more substances constituting the accompanying object of the target product SHH, and weights of the one or more substances.

In this embodiment, it is assumed that the product constituent substance information DX includes the main body constituent substance information DX1 and the accompanying-object constituent substance information DX2, but the present disclosure is not limited to such an aspect. The product constituent substance information DX may include only a portion of the main body constituent substance information DX1 and the accompanying-object constituent substance information DX2. For example, the product constituent substance information DX may include the main body constituent substance information DX1 and not include the accompanying-object constituent substance information DX2.

The product manufacturing characteristic information DY includes product manufacturing region information DY1, material manufacturing region information DY2, and product manufacturing method information DY3.

The product manufacturing region information DY1 indicates a region where the target product SHH is manufactured. Specifically, the product manufacturing region information DY1 may indicate, for example, some or all of a country in which the facility that manufactured the target article SHH exists, a local public organization in which the facility that manufactured the target article SHH exists, and an address of the facility that manufactured the target article SHH. Here, the facility where the target product SHH is manufactured may be, for example, a factory where the target product SHH is manufactured when the target product SHH is an industrial product, or may be a farm where the target product SHH is cultivated when the target product SHH is an agricultural product.

The material manufacturing region information DY2 indicates a region where the material of the target product SHH is manufactured. Specifically, the material manufacturing region information DY2 may indicate, for example, some or all of a country in which the facility that manufactured the target article SHH exists, a local public organization in which the facility that manufactured the target article SHH exists, and an address of the facility that manufactured the target article SHH. Here, the facility where the material of the target product SHH is manufactured may be, for example, a mine where the material of the target product SHH is mined when the target product SHH is an industrial product and the material of the target product SHH is a mineral, or a farm where the material of the target product SHH is cultivated when the target product SHH is a processed agricultural product and the material of the target product SHH is a plant.

The product manufacturing method information DY3 indicates a manufacturing method of the target product SHH.

Note that it is assumed, in this embodiment, that the product manufacturing characteristic information DY includes the product manufacturing region information DY1, the material manufacturing region information DY2, and the product manufacturing method information DY3, but the present disclosure is not limited to such an aspect. The product manufacturing characteristic information DY may include only some of the product manufacturing region information DY1, the material manufacturing region information DY2, and the product manufacturing method information DY3. For example, the product manufacturing characteristic information DY may include the product manufacturing region information DY1 and the material manufacturing region information DY2, but may not include the product manufacturing method information DY3.

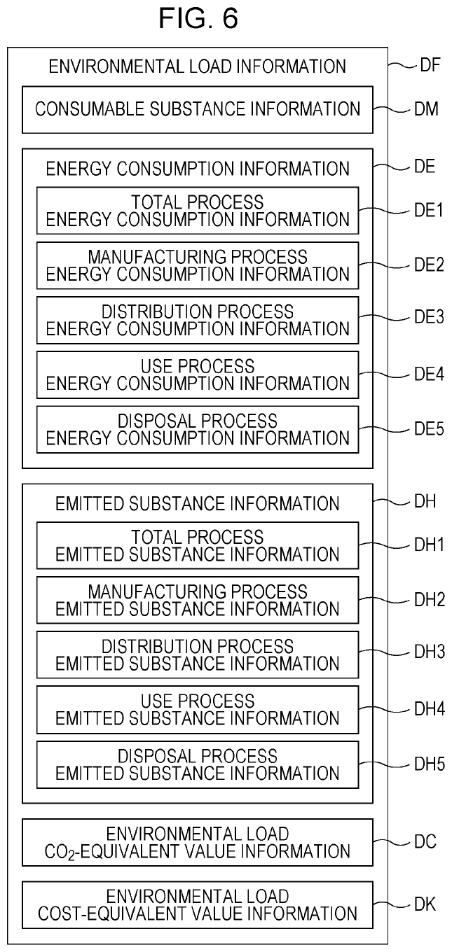

FIG. 6 is a block diagram illustrating an example of a data structure of the environmental load information DF.

As illustrated in FIG. 6, in this embodiment, the environmental load information DF includes consumable substance information DM, energy consumption information DE, emitted substance information DH, environmental load CO₂-equivalent value information DC, and environmental load cost-equivalent value information DK.

The consumable substance information DM indicates substance names of one or more substances consumed in a life cycle of the target product SHH, such as production, distribution, use, and disposal of the target product SHH, and weights of the one or more substances.

The energy consumption information DE includes total process energy consumption information DE1, manufacturing process energy consumption information DE2, distribution process energy consumption information DE3, use process energy consumption information DE4, and disposal process energy consumption information DE5, and indicates energy consumed in the life cycle of the target product SHH.

The manufacturing process energy consumption information DE2 indicates an amount of energy consumed for manufacturing the target product SHH in the manufacturing process in the life cycle of the target product SHH.

The distribution process energy consumption information DE3 indicates an amount of energy consumed for distribution of the target product SHH in the distribution process in the life cycle of the target product SHH.

The use process energy consumption information DE4 indicates an amount of energy consumed for the use of the target product SHH in the use process in the life cycle of the target product SHH.

The disposal process energy consumption information DE5 indicates an amount of energy consumed for disposal of the target product SHH in the disposal process in the life cycle of the target product SHH.

The total process energy consumption information DE1 indicates an amount of energy consumed by executing all the processes of the life cycle of the target product SHH. That is, the total process energy consumption information DE1 indicates a sum of the energy amount indicated by the manufacturing process energy consumption information DE2, the energy amount indicated by the distribution process energy consumption information DE3, the energy amount indicated by the use process energy consumption information DE4, and the energy amount indicated by the disposal process energy consumption information DE5.

The emitted substance information DH includes total process emitted substance information DH1, manufacturing process emitted substance information DH2, distribution process emitted substance information DH3, use process emitted substance information DH4, and disposal process emitted substance information DH5, and indicates names of one or more substances emitted in the life cycle of the target product SHH and weights of the one or more substances.

The manufacturing process emitted substance information DH2 indicates names of one or more substances emitted in the manufacturing process and weights of the one or more substances in the life cycle of the target product SHH.

The distribution process emitted substance information DH3 indicates names of one or more substances emitted in the distribution process in the life cycle of the target product SHH and weights of the one or more substances.

The use process emitted substance information DH4 indicates names of one or more substances emitted in the use process in the life cycle of the target product SHH and weights of the one or more substances.

The disposal process emitted substance information DH5 indicates names of one or more substances emitted in the disposal process in the life cycle of the target product SHH and weights of the one or more substances.

The total process emitted substance information DH1 indicates names of one or more substances emitted when all the processes in the life cycle of the target product SHH are executed and weights of the one or more substances. That is, the total process emitted substance information DH1 indicates the names and the weights of one or more substances indicated by the manufacturing process emitted substance information DH2, the names and the weights of one or more substances indicated by the distribution process emitted substance information DH3, the names and the weights of one or more substances indicated by the use process emitted substance information DH4, and the names and the weights of one or more substances indicated by the disposal process emitted substance information DH5.

The environmental load CO₂-equivalent value information DC indicates an environmental load CO₂-equivalent value AC obtained by converting a load applied to the environment by executing all the processes of the life cycle of the target product SHH into an amount of emitted carbon dioxide. Here, the environmental load CO₂-equivalent value AC may be, for example, an amount of emitted carbon dioxide in a case where a total amount of greenhouse gases emitted by executing all the processes of the life cycle of the target product SHH is converted into carbon dioxide while a degree of influence of global warming is maintained.

The environmental load cost-equivalent value information DK indicates an environmental load cost-equivalent value AK obtained by converting a load applied to the environment by executing all the processes of the life cycle of the target product SHH into a money amount. Here, the environmental load cost-equivalent value AK may be, for example, a value indicating a cost required to restore a damage given to the environment by executing all the processes of the life cycle of the target product SHH to an original state.

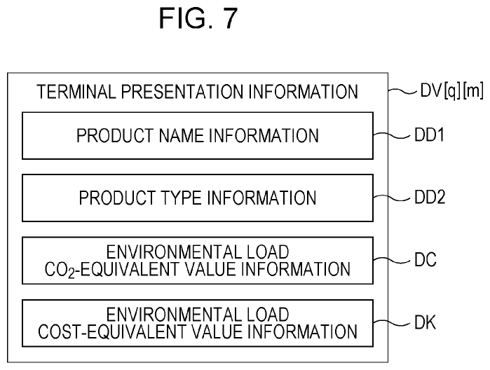

FIG. 7 is a block diagram illustrating an example of a data structure of the terminal presentation information DV.

As illustrated in FIG. 7, in this embodiment, the terminal presentation information DV includes the product name information DD1, the product type information DD2, the environmental load CO₂-equivalent value information DC, and the environmental load cost-equivalent value information DK.

In this embodiment, it is assumed that the storage device 20 stores a plurality of pieces of terminal presentation information DV transmitted to each of the Q terminal devices 5[1] to 5[Q] once or a plurality of times. Hereinafter, among the plurality of pieces of terminal presentation information DV stored in the storage device 20, the terminal presentation information DV transmitted for the m-th time to the terminal device 5[q] is referred to as terminal presentation information DV[q][m]. In this case, the variable m is a positive integer satisfying “1≤m≤M”. The value M is a positive integer satisfying “M≥1”.

The description now returns to FIG. 3.

As illustrated in FIG. 3, the product characteristic learning model NT includes an image classification learning model NT1, an image recognition learning model NT2, a product composition learning model NT3, and a product manufacturing learning model NT4.

The image classification learning model NT1 is, for example, a multilayer neural network. The image classification learning model NT1 is obtained by learning the relationship between a captured image of the product-associated object SK and classification of the product-associated object SK using an image obtained by imaging the product-associated object SK corresponding to the product SH as input data and a result of classification of the product-associated object SK as teacher data. Specifically, in a case where the imaging information DG indicating the result of the imaging of the product-associated object SK corresponding to the target product SHH is input, the image classification learning model NT1 outputs a classification item of the product-associated object SK corresponding to the target product SHH. As described above, in this embodiment, as an example, it is assumed that the product-associated object SK is classified into any one of classification items including the product main body SH1, the product package SH2, the product advertisement SH3, the product composition table SH4, the product content label SH5, the product manufacturing information table SH6, and the product barcode SH7.

The image recognition learning model NT2 is, for example, a multilayer neural network. The image recognition learning model NT2 is obtained by learning the relationship between an image obtained by imaging the product-associated object SK, a classification item of the product-associated object SK, and content of the image using an image obtained by capturing the product-associated object SK corresponding to the product SH and a classification item of the product-associated object SK as input data and content of the image as teacher data. Specifically, the image recognition learning model NT2 outputs the product characteristic information DD corresponding to the product-associated object SK corresponding to the target product SHH when the imaging information DG indicating the result of imaging the product-associated object SK corresponding to the target product SHH and the classification item corresponding to the imaging information DG are input.

Specifically, when the imaging information DG indicating the product main body image GG1 corresponding to the target product SHH is input, the image recognition learning model NT2 outputs the product name information DD1 and the product type information DD2 corresponding to the target product SHH. Furthermore, when the imaging information DG indicating the product package image GG2 corresponding to the target product SHH is input, the image recognition learning model NT2 outputs the product name information DD1 and the product type information DD2 corresponding to the target product SHH. In a case where the imaging information DG indicating the product advertisement image GG3 corresponding to the target product SHH is input, the image recognition learning model NT2 outputs the product name information DD1 and the product type information DD2 corresponding to the target product SHH. In a case where the imaging information DG indicating the product composition table image GG4 corresponding to the target product SHH is input, the image recognition learning model NT2 outputs the product constituent substance information DX corresponding to the target product SHH. In a case where the imaging information DG indicating the product content label image GG5 corresponding to the target product SHH is input, the image recognition learning model NT2 outputs the product constituent substance information DX and the product manufacturing characteristic information DY corresponding to the target product SHH. In a case where the imaging information DG indicating the product manufacturing information image GG6 corresponding to the target product SHH is input, the image recognition learning model NT2 outputs the product manufacturing characteristic information DY corresponding to the target product SHH. In a case where the imaging information DG indicating the product barcode image GG7 corresponding to the target product SHH is input, the image recognition learning model NT2 outputs the product constituent substance information DX and the product manufacturing characteristic information DY corresponding to the target product SHH.

The product composition learning model NT3 is, for example, a multilayer neural network. The product composition learning model NT3 is obtained by learning the relationship between the product name information DD1 and the product type information DD2 corresponding to the product SH and the product constituent substance information DX corresponding to the product SH using the product name information DD1 and the product type information DD2 as input data and the product constituent substance information DX corresponding to the product SH as teacher data. Specifically, when the product name information DD1 and the product type information DD2 corresponding to the target product SHH are input, the product composition learning model NT3 outputs the product constituent substance information DX corresponding to the target product SHH.

The product manufacturing learning model NT4 is, for example, a multilayer neural network. The product manufacturing learning model NT4 is obtained by learning the relationship between the product name information DD1 and the product type information DD2 corresponding to the product SH and the product manufacturing characteristic information DY corresponding to the product SH using the product name information DD1 and the product type information DD2 as input data and the product manufacturing characteristic information DY corresponding to the product SH as teacher data. Specifically, when the product name information DD1 and the product type information DD2 corresponding to the target product SHH are input, the product manufacturing learning model NT4 outputs the product manufacturing characteristic information DY corresponding to the target product SHH.

The environmental load learning model NF is, for example, a multilayer neural network. The environmental load learning model NF is obtained by learning the relationship between the product constituent substance information DX and the product manufacturing characteristic information DY corresponding to the product SH and the environmental load information DF corresponding to the product SH using the product constituent substance information DX and the product manufacturing characteristic information DY corresponding to the product SH as input data and the environmental load information DF corresponding to the product SH as teacher data. Specifically, when the product constituent substance information DX and the product manufacturing characteristic information DY corresponding to the target product SHH are input, the environmental load learning model NF outputs the environmental load information DF corresponding to the target product SHH. Note that, in this embodiment, it is assumed that the environmental load learning model NF can output the environmental load information DF corresponding to the target product SHH even when one of the product constituent substance information DX and the product manufacturing characteristic information DY corresponding to the target product SHH is input.

The control device 10 includes a processor. The processor included in the control device 10 includes, for example, one or more CPUs. However, the processor included in the control device 10 may include hardware, such as a GPU, a DSP, an ASIC, a PLD, or an FPGA in addition to one or more CPUs or instead of some or all of one or more CPUs. The processor included in the control device 10 functions as an information acquisition section 11, an environmental load estimation section 12, and an information presentation section 13 by executing a control program PG stored in the storage device 20 and operating in accordance with the control program PG.

The information acquisition section 11 acquires the imaging information DG from the terminal device 5[q]. Furthermore, when the user U[q] of the terminal device 5[q] inputs information from the input device 55 by operating the input device 55 included in the terminal device 5[q], the information acquisition section 11 acquires the input information.

The environmental load estimation section 12 includes a product characteristic information generation section 121 and an environmental load information generation section 122.

The product characteristic information generation section 121 generates the product characteristic information DD based on the imaging information DG using the product characteristic learning model NT.

The environmental load information generation section 122 generates the environmental load information DF based on the product characteristic information DD using the environmental load learning model NF.

The information presentation section 13 generates the terminal presentation information DV based on the product characteristic information DD and the environmental load information DF, and presents the generated terminal presentation information DV on the terminal device 5[q].

The communication device 30 is hardware for communicating with an external device existing outside the server apparatus 1 via the network NW. In this embodiment, the information acquisition section 11 acquires the imaging information DG from the terminal device 5[q] via the communication device 30. The information presentation section 13 presents the terminal presentation information DV on the terminal device 5[q] via the communication device 30.

### A.2. Information Presented by Environmental Load Estimation System Sys

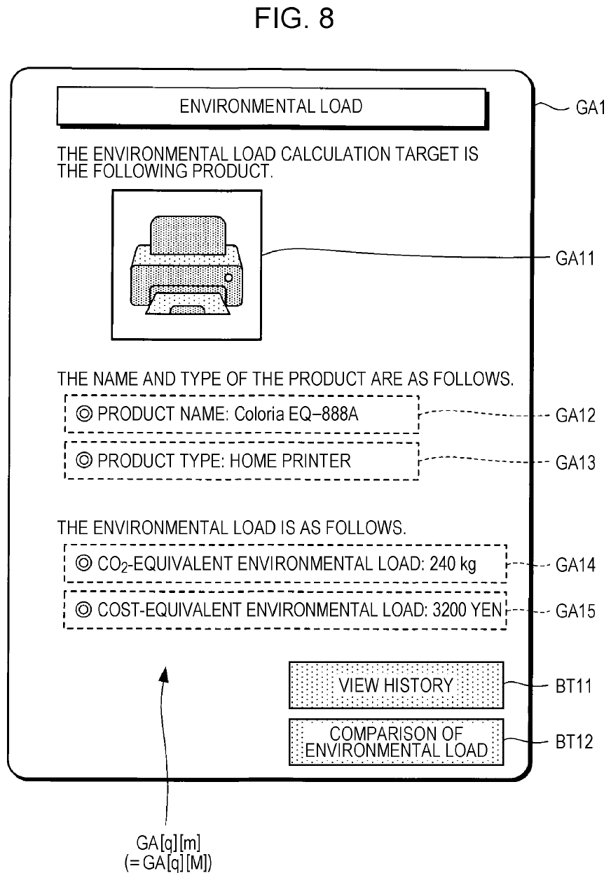

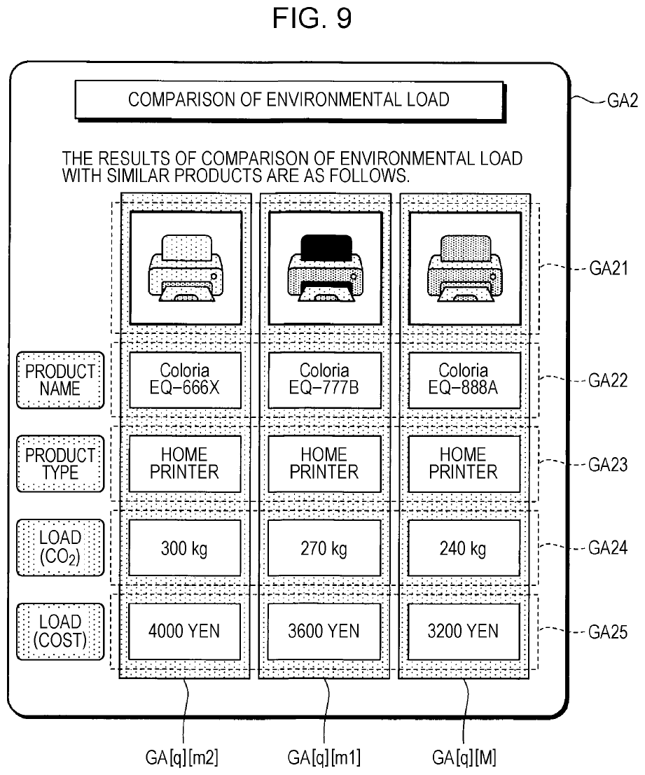

Hereinafter, the terminal presentation information DV presented on the terminal device 5[q] in the environmental load estimation system Sys according to the first embodiment will be described with reference to FIGS. 8 and 9.

FIG. 8 is a diagram schematically illustrating an example of the environmental load presenting screen GA1 displayed on the display device 54 in the terminal device 5[q] to which the terminal presentation information DV is supplied. In this embodiment, as an example, it is assumed that the terminal presentation information DV includes the product name information DD1, the product type information DD2, the environmental load CO₂-equivalent value information DC, and the environmental load cost-equivalent value information DK, and is display information for causing the terminal device 5[q] to display the environmental load presenting screen GA1. However, the present disclosure is not limited to this aspect. The terminal presentation information DV may be information other than the display information. For example, the terminal presentation information DV may be voice information that includes the product name information DD1, the product type information DD2, the environmental load CO₂-equivalent value information DC, and the environmental load cost-equivalent value information DK, and sounds these pieces of information on the terminal device 5[q].

As illustrated in FIG. 8, the environmental load presenting screen GA1 includes a target product image display region GA11, a target product name display region GA12, a target product type display region GA13, an environmental load CO₂-equivalent value display region GA14, an environmental load cost-equivalent value display region GA15, a history display button BT11, and an environmental load comparison button BT12.

In the target product image display region GA11, an image of the product main body of the target product SHH is displayed. Specifically, when the imaging information DG indicates the product main body image GG1, the product main body image GG1 may be displayed in the target product image display region GA11.

A name of the target product SHH is displayed in the target product name display region GA12. Specifically, the name of the target product SHH indicated by the product name information DD1 is displayed in the target product name display region GA12.

In the target product type display region GA13, a type of the target product SHH is displayed. Specifically, the product type of the target product SHH indicated by the product type information DD2 is displayed in the target product type display region GA13.

An environmental load CO₂-equivalent value of the environmental load applied by the target product SHH is displayed in the environmental load CO₂-equivalent value display region GA14. Specifically, a CO₂ emission amount indicated by the environmental load CO₂-equivalent value information DC is displayed in the environmental load CO2-equivalent value display region GA14.

In the environmental load cost-equivalent value display region GA15, a cost-equivalent value of the environmental load applied by the target product SHH is displayed. Specifically, the cost-equivalent value of the environmental load indicated by the environmental load cost-equivalent value information DK is displayed in the environmental load cost-equivalent value display region GA15.

Note that the target product image display region GA11, the target product name display region GA12, the target product type display region GA13, the environmental load CO₂-equivalent value display region GA14, and the environmental load cost-equivalent value display region GA15 are referred to as an environmental load display region GA[q][m], and the information displayed in the environmental load display region GA[q][m] is referred to as environmental load display information DA[q][m].

As described above, the environmental load display information DA[q][m] includes the product name information DD1, the product type information DD2, the environmental load CO₂-equivalent value information DC, and the environmental load cost-equivalent value information DK.

Note that, when the user U[q] captures an image of the target product SHH using the terminal device 5[q], the terminal presentation information DV supplied to the terminal device 5[q] by the server apparatus 1 is an M-th latest terminal presentation information DV among M pieces of terminal presentation information DV supplied to the terminal device 5[q] by the server apparatus 1 up to the present. Therefore, the environmental load display information DA displayed on the environmental load presenting screen GA1 viewed by the user U[q] may also be referred to as environmental load display information DA[q] [M].

When the user U[q] presses the history display button BT11 using the input device 55, an environmental load list screen (not illustrated) is displayed on the display device 54. On the environmental load list screen, M pieces of environmental load display information DA[q][1] to DA[q] [M] displayed so far by the terminal device 5[q] are displayed in a list as a display history.

When the user U[q] presses the environmental load comparison button BT12 using the input device 55, the environmental load comparison screen GA2 is displayed on the display device 54.

FIG. 9 is a diagram schematically illustrating an example of the environmental load comparison screen GA2 displayed on the display device 54 included in the terminal device 5[q]. The environmental load comparison screen GA2 displays a list of the environmental load display information DA[q][M] displayed last and the environmental load display information DA[q][m] corresponding to a product SH having the same product type as the target product SHH indicated by the environmental load display information DA[q][M], among the M pieces of environmental load display information DA[q][1] to DA[q][M] displayed so far in the terminal device 5[q]. In FIG. 9, as an example, it is assumed that a product SH corresponding to a terminal presentation information DV[q][m1] supplied from the server apparatus 1 to the terminal device 5[q] as m1-th information and a product SH corresponding to a terminal presentation information DV [q][m2] supplied from the server apparatus 1 to the terminal device 5[q] as m2-th information have the same product type as the target product SHH (in the example of FIG. 9, the product type is “home printer”). The variable m1 is a positive integer satisfying “1<m1<M”. The variable m2 is a positive integer satisfying “1≤m2<m1”.

As illustrated in FIG. 9, the environmental load comparison screen GA2 includes one or more environmental load display regions GA[q][m] in one-to-one correspondence with one or more pieces of environmental load display information DA[q][m] to be displayed on the environmental load comparison screen GA2. As described above, in the example illustrated in FIG. 9, it is assumed that the environmental load comparison screen GA2 includes three environmental load display regions GA[q][m], that is, an environmental load display region GA[q][M], an environmental load display region GA[q][m1], and an environmental load display region GA[q][m2].

Each of the environmental load display region GA[q][m] of the environmental load comparison screen GA2 includes a target product image display region GA21, a target product name display region GA22, a target product type display region GA23, an environmental load CO2-equivalent value display region GA24, and an environmental load cost-equivalent value display region GA25.

An image of the product main body indicating the product SH corresponding to the environmental load display information DA[q][m] is displayed in the target product image display region GA21 included in the environmental load display region GA[q][m] of the environmental load comparison screen GA2.

A name of the product SH indicated by the product name information DD1 included in the environmental load display information DA[q][m] is displayed in the target product name display region GA22 included in the environmental load display region GA[q][m] of the environmental load comparison screen GA2.

A product type of the product SH indicated by the product type information DD2 included in the environmental load display information DA[q][m] is displayed in the target product type display region GA23 included in the environmental load display region GA[q][m] of the environmental load comparison screen GA2.

A CO₂ emission amount indicated by the environmental load CO₂-equivalent value information DC included in the environmental load display information DA[q] [m] is displayed in the environmental load CO₂-equivalent value display region GA24 included in the environmental load display region GA[q][m] of the environmental load comparison screen GA2.

A cost-equivalent value of an environmental load indicated by the environmental load cost-equivalent value information DK included in the environmental load display information DA[q][m] is displayed in the environmental load cost-equivalent value display region GA25 included in the environmental load display region GA[q][m] of the environmental load comparison screen GA2.

As described above, in this embodiment, based on the product-associated object SK of the target product SHH captured by the user U[q] using the terminal device 5[q], the display device 54 of the terminal device 5[q] displays the environmental load presenting screen GA1 including the product name information DD1, the product type information DD2, the environmental load CO₂-equivalent value information DC, and the environmental load cost-equivalent value information DK corresponding to the target product SHH. Therefore, according to this embodiment, the user U[q] considering purchasing the target product SHH can recognize a load of the target product SHH on the environment, and the user U[q] can be urged to be conscious of environmental protection.

In this embodiment, in the environmental load comparison screen GA2, one or more pieces of environmental load display information DA[q][m] corresponding to one or more products SH having the same product type as the target product SHH captured by the user U[q] using the terminal device 5[q] are displayed for comparison. Therefore, according to this embodiment, the user U[q] considering purchasing the target product SHH can compare the load of the target product SHH on the environment with the similar products of the target product SHH, and the user U[q] can be motivated to purchase a more environmentally friendly product.

### A.3. Operation of Environmental Load Estimation System Sys

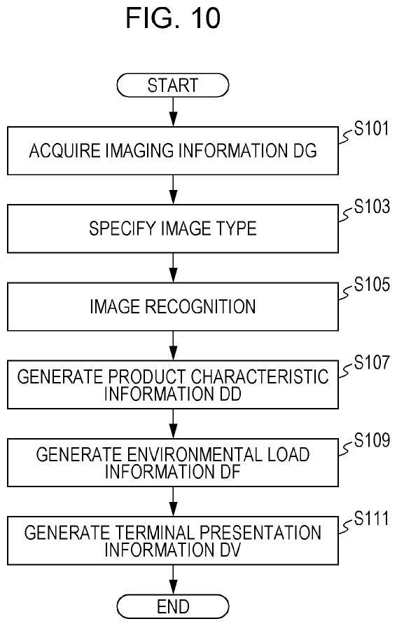

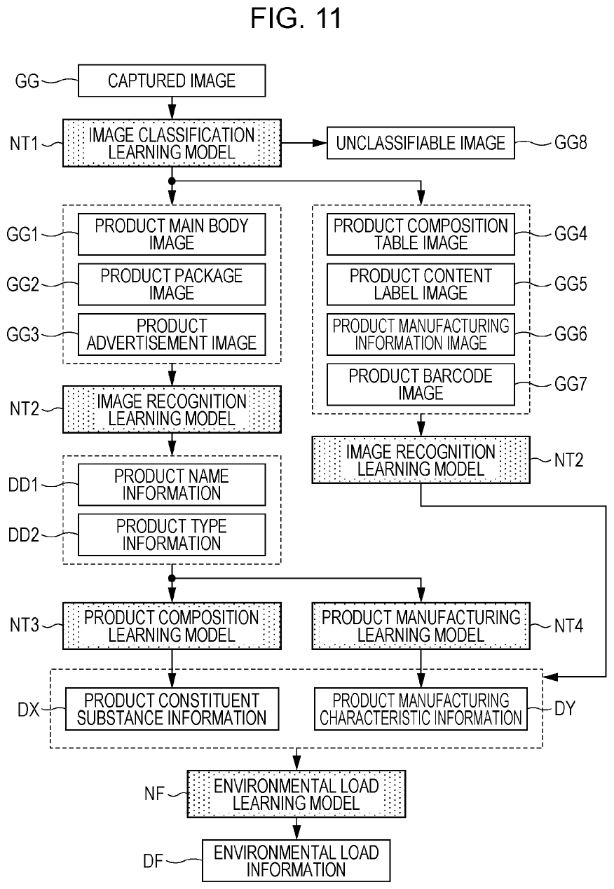

Hereinafter, an example of operation of the environmental load estimation system Sys according to the first embodiment will be described with reference to FIGS. 10 and 11. Hereinafter, the process of estimating an environmental load of the target product SHH based on the imaging information DG supplied from the terminal device 5[q] that has captured the image of the target product SHH performed by the server apparatus 1 may be referred to as an environmental load estimation process.

FIG. 10 is a flowchart illustrating an example of the operation of the server apparatus 1 performed when the server apparatus 1 executes the environmental load estimation process. Note that the server apparatus 1 starts the environmental load estimation process when the imaging information DG is supplied from the terminal device 5[q].

As illustrated in FIG. 10, when the environmental load estimation process is started, the information acquisition section 11 of the server apparatus 1 acquires imaging information DG supplied from the terminal device 5[q] (S101).

Subsequently, the product characteristic information generation section 121 of the server apparatus 1 specifies an image type of a captured image GG indicated by the imaging information DG acquired in step S101 using the image classification learning model NT1 (S103).

The product characteristic information generation section 121 of the server apparatus 1 recognizes content of the captured image GG specified in step S103 by using the image recognition learning model NT2 (S105).

The product characteristic information generation section 121 of the server apparatus 1 generates product characteristic information DD based on the content of the captured image GG recognized in step S105 by using the product characteristic learning model NT (S107).

The environmental load information generation section 122 of the server apparatus 1 generates environmental load information DF based on the product characteristic information DD generated in step S107 by using the environmental load learning model NF (S109).

Thereafter, the information presentation section 13 of the server apparatus 1 generates terminal presentation information DV based on the environmental load information DF generated in step S109 (S111), transmits the generated terminal presentation information DV to the terminal device 5[q], and then terminates the environmental load estimation process illustrated in the flowchart of FIG. 10.

FIG. 11 is a diagram schematically illustrating an example of a data flow in the server apparatus 1 when the server apparatus 1 executes the environmental load estimation process.

As illustrated in FIG. 11, when the environmental load estimation process is started and the imaging information DG obtained by imaging the product-associated object SK of the target product SHH is supplied from the terminal device 5[q], the product characteristic information generation section 121 inputs the imaging information DG to the image classification learning model NT1, thereby acquiring a classification item of the product-associated object SK output from the image classification learning model NT1.

Subsequently, in a case where the captured image GG indicated by the imaging information DG corresponding to the target product SHH is the product main body image GG1, the product package image GG2, or the product advertisement image GG3, the product characteristic information generation section 121 acquires product name information DD1 and product type information DD2 output from the image recognition learning model NT2 by inputting the imaging information DG to the image recognition learning model NT2.

When the captured image GG indicated by the imaging information DG corresponding to the target product SHH is the product composition table image GG4, the product content label image GG5, the product manufacturing information image GG6, or the product barcode image GG7, the product characteristic information generation section 121 inputs the imaging information DG to the image recognition learning model NT2 to acquire one or both of product constituent substance information DX and product manufacturing characteristic information DY output from the image recognition learning model NT2.

When the captured image GG indicated by the imaging information DG corresponding to the target product SHH is the unclassifiable image GG8, it is difficult to generate product characteristic information DD. Therefore, the control device 10 terminates the environmental load estimation process. In this case, the information presentation section 13 may transmit, to the terminal device 5[q], a message for prompting the terminal device 5[q] to capture an image of the product-associated object SK of the target product SHH again.

Thereafter, the product characteristic information generation section 121 inputs the product name information DD1 and the product type information DD2 corresponding to the target product SHH to the product composition learning model NT3, thereby acquiring product constituent substance information DX output from the product composition learning model NT3.

In addition, the product characteristic

Information generation section 121 acquires product manufacturing characteristic information DY output from the product manufacturing learning model NT4 by inputting the product name information DD1 and the product type information DD2 corresponding to the target product SHH to the product manufacturing learning model NT4.

Thereafter, the environmental load information generation section 122 acquires environmental load information DF output from the environmental load learning model NF by inputting one or both of the product constituent substance information DX and the product manufacturing characteristic information DY corresponding to the target product SHH to the environmental load learning model NF.

Note that, in this embodiment, as an example, it is assumed that estimation accuracy of an environmental load by the environmental load learning model NF when both the product constituent substance information DX and the product manufacturing characteristic information DY are input to the environmental load learning model NF is higher than estimation accuracy of an environmental load by the environmental load learning model NF when only the product constituent substance information DX is input and the product manufacturing characteristic information DY is not input to the environmental load learning model NF.

Furthermore, in this embodiment, as an example, it is assumed that the estimation accuracy of the environmental load by the environmental load learning model NF when only the product constituent substance information DX is input and the product manufacturing characteristic information DY is not input to the environmental load learning model NF is higher than estimation accuracy of an environmental load by the environmental load learning model NF when only the product manufacturing characteristic information DY is input and the product constituent substance information DX is not input to the environmental load learning model NF.

Therefore, in this embodiment, when only the product constituent substance information DX is input to the environmental load learning model NF and the product manufacturing characteristic information DY is not input to the environmental load learning model NF, the information presentation section 13 may display that estimation accuracy of the environmental load display information DA is low on the environmental load presenting screen GA1 and the environmental load comparison screen GA2.

Furthermore, when only the product manufacturing characteristic information DY is input to the environmental load learning model NF and the product constituent substance information DX is not input to the environmental load learning model NF, the information presentation section 13 may display a message on the environmental load presenting screen GA1 to prompt the user to capture an image of the product-associated object SK of the target product SHH again since the estimation accuracy of the environmental load display information DA is extremely low.

As described above, in this embodiment, since the server apparatus 1 generates the environmental load information DF using the product characteristic learning model NT and the environmental load learning model NF, it is possible to estimate an environmental load applied to the environment by the target product SHH even in a case where the storage device 20 of the server apparatus 1 does not have information relating to the target product SHH in advance.

Furthermore, in this embodiment, since the server apparatus 1 generates the environmental load information DF based on the product-associated object SK of the target product SHH, it is possible to increase the opportunity for the user U[q] to recognize the environmental load applied by the target product SHH, for example, compared to an aspect in which the environmental load information DF is generated based on the product main body of the target product SHH.

### A.4. Modification of First Embodiment

This embodiment may be variously modified. Specific modifications will be described below as examples. Two or more aspects selected in any manner from the following examples can be combined with each other as appropriate within a range not inconsistent with each other. Note that, in the modifications described below, components having the same effects and functions as those described in the embodiment will be denoted by the same reference numerals as those referred to in the above description, and detailed descriptions thereof will be omitted as appropriate.

### Modification 1.1

In the first embodiment described above, a mode in which the server apparatus 1 generates the environmental load information DF from the product characteristic information DD using the environmental load learning model NF is described as an example, but the present disclosure is not limited to this mode. The server apparatus 1 may generate the environmental load information DF from the product characteristic information DD using an environmental load database DBF that stores the product constituent substance information DX and the product manufacturing characteristic information DY corresponding to the product SH and the environmental load information DF corresponding to the product SH in association with each other.

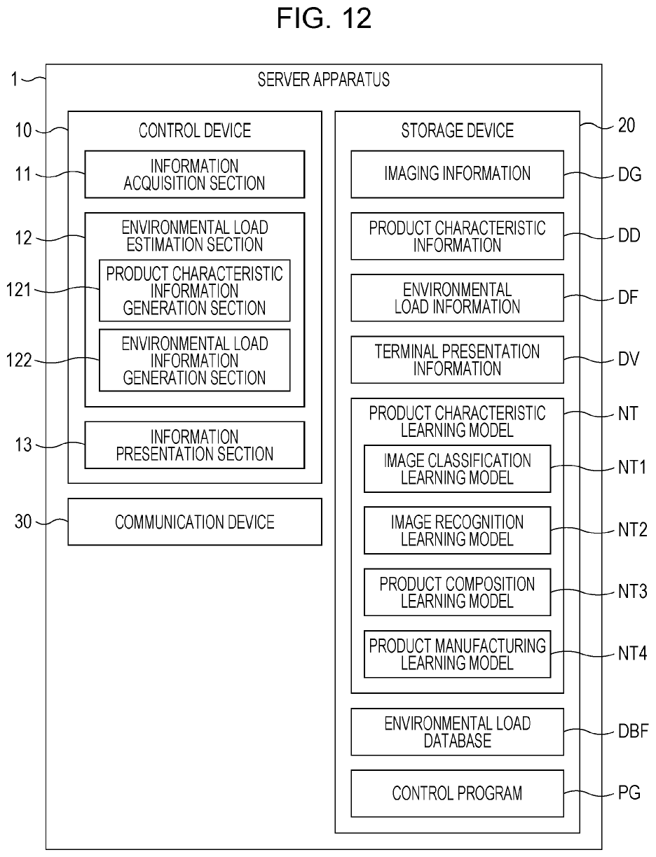

FIG. 12 is a block diagram illustrating an example of a configuration of a server apparatus 1 according to this modification.

As illustrated in FIG. 12, this modification is different from the embodiment in that the server apparatus 1 stores the environmental load database DBF instead of the environmental load learning model NF in the storage device 20.

Note that, in the example illustrated in FIG. 12, the environmental load database DBF is stored in the storage device 20, but the present disclosure is not limited to such an aspect. The environmental load database DBF may be included in an external device existing outside the server apparatus 1 or may be included in an external device installed outside the environmental load estimation system Sys.

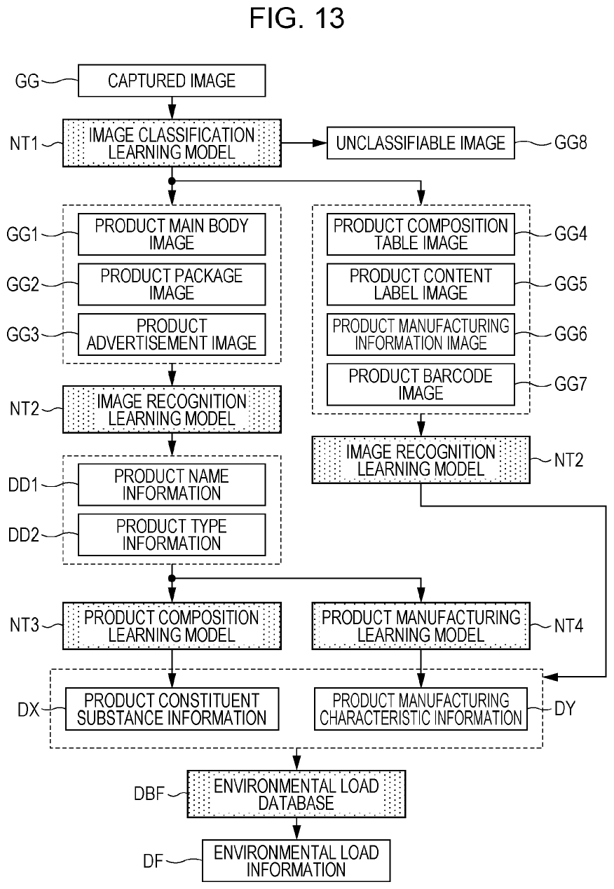

FIG. 13 is a diagram schematically illustrating an example of a data flow in the server apparatus 1 in a case where the server apparatus 1 according to this modification executes the environmental load estimation process. Note that, in this modification, the data flow is the same as that according to the first embodiment illustrated in FIG. 11 except that the environmental load information DF is generated using the environmental load database DBF instead of the environmental load learning model NF.

Specifically, in the environmental load estimation process according to this modification, as illustrated in FIG. 13, the environmental load information generation section 122 acquires environmental load information DF corresponding to product constituent substance information DX and product manufacturing characteristic information DY from the environmental load database DBF by referring to the environmental load database DBF with the product constituent substance information DX and the product manufacturing characteristic information DY as arguments.

Note that the environmental load database DBF may be configured by accumulating information relating to an ISO environmental label (type III) defined by ISO (International Organization for Standardization) 14025. Furthermore, the environmental load database DBF may be configured by accumulating information generated using a life cycle impact assessment method based on endpoint modeling (LIME).

As described above, according to this modification, since the environmental load information DF is generated using the environmental load database DBF, it is possible to accurately estimate an environmental load applied to an environment by a target product SHH in a case where the environmental load database DBF has information relating to the target product SHH in advance.

### Modification 1.2

In the first embodiment described above, a mode in which the server apparatus 1 generates the environmental load information DF from the imaging information DG using the product characteristic learning model NT and the environmental load learning model NF is described as an example, but the present disclosure is not limited to this mode. For example, the server apparatus 1 may generate the environmental load information DF from the imaging information DG using a single learning model in a process performed after the product-associated object SK is classified by the image classification learning model NT1.

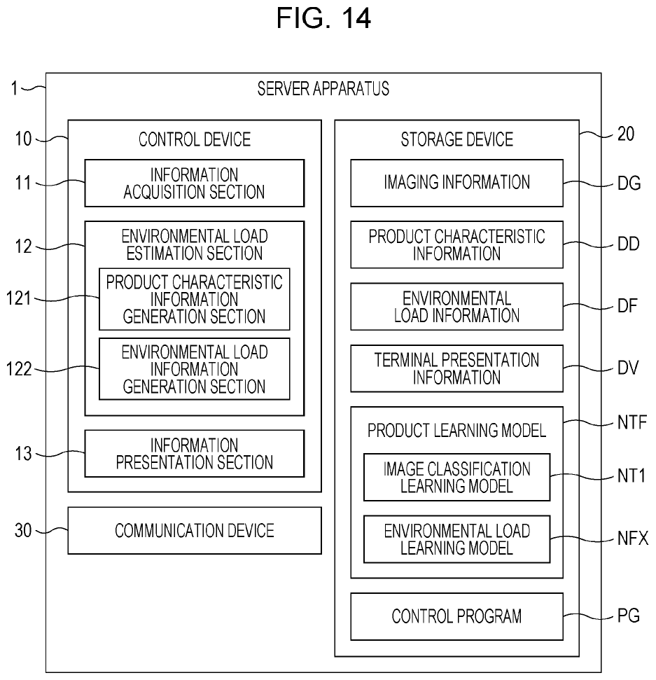

FIG. 14 is a block diagram illustrating an example of a configuration of the server apparatus 1 according to this modification.

As illustrated in FIG. 14, this modification is different from the embodiment in that the server apparatus 1 stores a product learning model NTF in the storage device 20 instead of the product characteristic learning model NT and the environmental load learning model NF.

The product learning model NTF includes an image classification learning model NT1 and an environmental load learning model NFX.

The environmental load learning model NFX is, for example, a multilayer neural network. The environmental load learning model NFX is obtained by learning the relationship between a captured image of the product-associated object SK of the product SH, a classification item of the product-associated object SK, and the environmental load information DF corresponding to the product SH by using the captured image of the product-associated object SK corresponding to the product SH and the classification item of the product-associated object SK as input data and the environmental load information DF corresponding to the product SH as teacher data. Specifically, the environmental load learning model NFX outputs the environmental load information DF corresponding to the target product SHH when imaging information DG indicating a result of imaging the product-associated object SK corresponding to the target product SHH and a classification item corresponding to the imaging information DG are input.

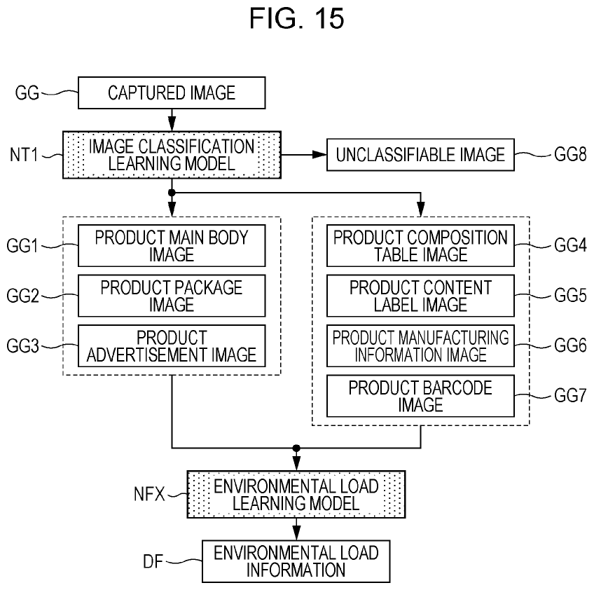

FIG. 15 is a diagram schematically illustrating an example of a data flow in the server apparatus 1 when the server apparatus 1 according to this modification executes the environmental load estimation process.

As illustrated in FIG. 15, when the environmental load estimation process is started and the imaging information DG of the product-associated object SK of the target product SHH is supplied from the terminal device 5[q], the product characteristic information generation section 121 inputs the imaging information DG to the image classification learning model NT1, thereby acquiring a classification item of the product-associated object SK output from the image classification learning model NT1.

Thereafter, the environmental load information generation section 122 acquires the environmental load information DF output from the environmental load learning model NFX by inputting the imaging information DG corresponding to the product-associated object SK of the target product SHH and the classification item of the product-associated object SK to the environmental load learning model NFX.

In this way, in this modification, since the server apparatus 1 generates the environmental load information DF using the environmental load learning model NFX, it is possible to estimate an environmental load of the target product SHH even in a case where the storage device 20 of the server apparatus 1 does not have information relating to the target product SHH in advance.

### Modification 1.3

In the first embodiment and the modifications described above, the case where the environmental load estimation section 12 generates the environmental load information DF based on the imaging information DG indicating a result of imaging the product-associated object SK having a single classification item has been described as an example, but the present disclosure is not limited to such an aspect. The environmental load estimation section 12 may generate the environmental load information DF based on the imaging information DG indicating a result of capturing an image of the product-associated object SK having a plurality of classification items.

In this modification, the imaging information DG indicates a result of imaging the product-associated object SK having a plurality of classification items among the seven classification items of the product main body SH1, the product package SH2, the product advertisement SH3, the product composition table SH4, the product content label SH5, the product manufacturing information table SH6, and the product barcode SH7. Specifically, in this modification, the captured image GG indicated by the imaging information DG includes a plurality of partial images GGsub corresponding to a plurality of classification items.

In addition, in this modification, in a case where the imaging information DG indicating the captured image GG corresponding to the target product SHH and including the plurality of partial images GGsub is input, the image classification learning model NT1 outputs a plurality of image types corresponding to the plurality of partial images GGsub.

In this modification, when the plurality of partial images GGsub corresponding to the target product SHH and the plurality of image types corresponding to the plurality of partial images GGsub are input, the image recognition learning model NT2 outputs some or all of the single product name information DD1, the single product type information DD2, the single product constituent substance information DX, and the single product manufacturing characteristic information DY based on the input plurality of partial images GGsub.

Furthermore, in this modification, similarly to the first embodiment described above, when the product name information DD1 and the product type information DD2 corresponding to the target product SHH are input, the product composition learning model NT3 outputs the product constituent substance information DX corresponding to the target product SHH.

Furthermore, in this modification, similarly to the first embodiment described above, when the product name information DD1 and the product type information DD2 corresponding to the target product SHH are input, the product manufacturing learning model NT4 outputs the product manufacturing characteristic information DY corresponding to the target product SHH.

Moreover, in this modification, similarly to the first embodiment described above, when one or both of the product constituent substance information DX and the product manufacturing characteristic information DY corresponding to the target product SHH are input, the environmental load learning model NF outputs the environmental load information DF corresponding to the target product SHH.

As described above, in this modification, the environmental load estimation section 12 generates the environmental load information DF based on the product-associated object SK having a plurality of classification items. Therefore, it is possible to more accurately estimate the environmental load of the target product SHH.

### Modification 1.4

In the first embodiment and the modifications described above, it is assumed that the environmental load estimation section 12 can identify the product-associated object SK corresponding to the target product SHH in the captured image GG indicated by the imaging information DG. However, the present disclosure is not limited to such an aspect. It may be assumed that the environmental load estimation section 12 cannot identify the product-associated object SK corresponding to the target product SHH in the captured image GG indicated by the imaging information DG. For example, it may be assumed that the environmental load estimation section 12 cannot identify the product-associated object SK corresponding to the target product SHH in the captured image GG indicated by the imaging information DG, for example, when a product-associated object SK of a product SH different from the target product SHH is mixed in the captured image GG indicated by the imaging information DG in addition to the product-associated object SK corresponding to the target product SHH.

In this modification, when the environmental load estimation section 12 cannot identify the product-associated object SK corresponding to the target product SHH in the captured image GG indicated by the imaging information DG, the information presentation section 13 supplies the terminal device 5[q] with a message prompting the terminal device 5[q] to perform an operation for identifying the product-associated object SK corresponding to the target product SHH in the captured image GG. Then, when the user U[q] executes an operation of identifying the product-associated object SK of the target product SHH from among a plurality of product-associated objects SK corresponding to a plurality of products SH included in the captured image GG displayed on the display device 54, the terminal device 5[q] transmits operation information indicating a result of the operation to the server apparatus 1. Subsequently, the information acquisition section 11 acquires operation information supplied from the terminal device 5[q]. Then, the environmental load estimation section 12 identifies the product-associated object SK corresponding to the target product SHH from the captured image GG based on the operation information, and generates the environmental load information DF based on the result of the identification.

As described above, in this modification, the environmental load estimation section 12 identifies the product-associated object SK corresponding to the target product SHH from the captured image GG based on the operation information. Therefore, it is possible to reduce the risk that environmental loads of the products SH different from the target product SHH of which the user U[q] tries to recognize the environmental load is erroneously presented to the user U[q].

### B.1. Second Embodiment

Hereinafter, a second embodiment of the present disclosure will be described. In the second embodiment, components having the same operations and functions as those in the first embodiment are denoted by the same reference numerals as those used in the above description, and the detailed description thereof will be appropriately omitted.

An environmental load estimation system (not illustrated) according to the second embodiment is different from the environmental load estimation system Sys according to the first embodiment in that a server apparatus 1B is provided instead of the server apparatus 1. Furthermore, the environmental load estimation system according to the second embodiment is different from the environmental load estimation system Sys according to the first embodiment in that the environmental load estimation system according to the second embodiment executes a product identification result correction process of correcting product name information DD1 or product type information DD2 generated by the server apparatus 1B in accordance with an input by the user U[q] of the terminal device 5[q].

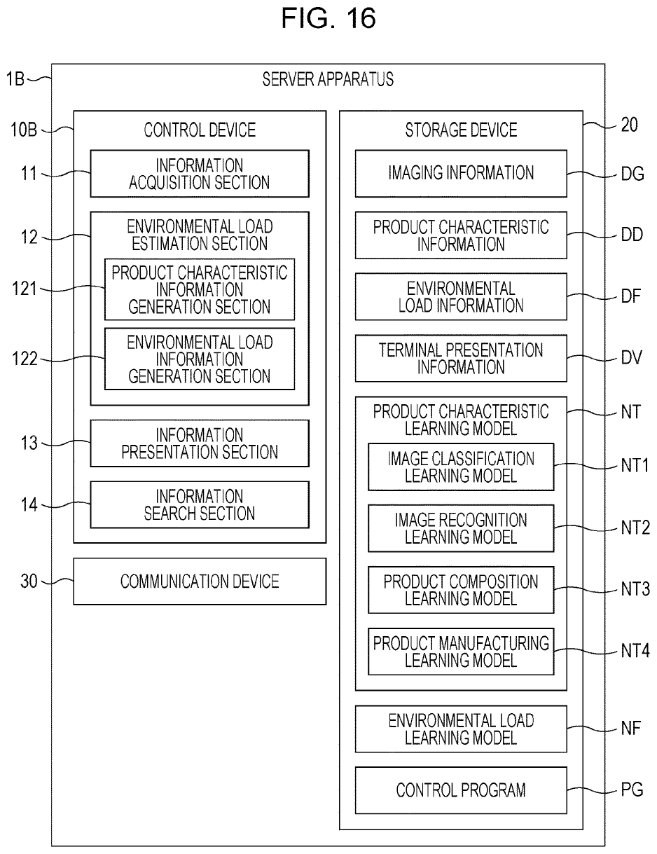

FIG. 16 is a block diagram illustrating an example of a configuration of the server apparatus 1B.

As illustrated in FIG. 16, the server apparatus 1B is different from the server apparatus 1 according to the first embodiment in that the server apparatus 1B includes a control device 10B instead of the control device 10. The control device 10B is different from the control device 10 according to the first embodiment in that the control device 10B includes an information search section 14. The information search section 14 searches an external device for information and acquires necessary information.

When generating the terminal presentation information DV in the environmental load estimation process, the server apparatus 1B supplies the terminal presentation information DV to the terminal device 5[q] thereby causing the terminal device 5[q] to display an environmental load presenting screen GA1B.

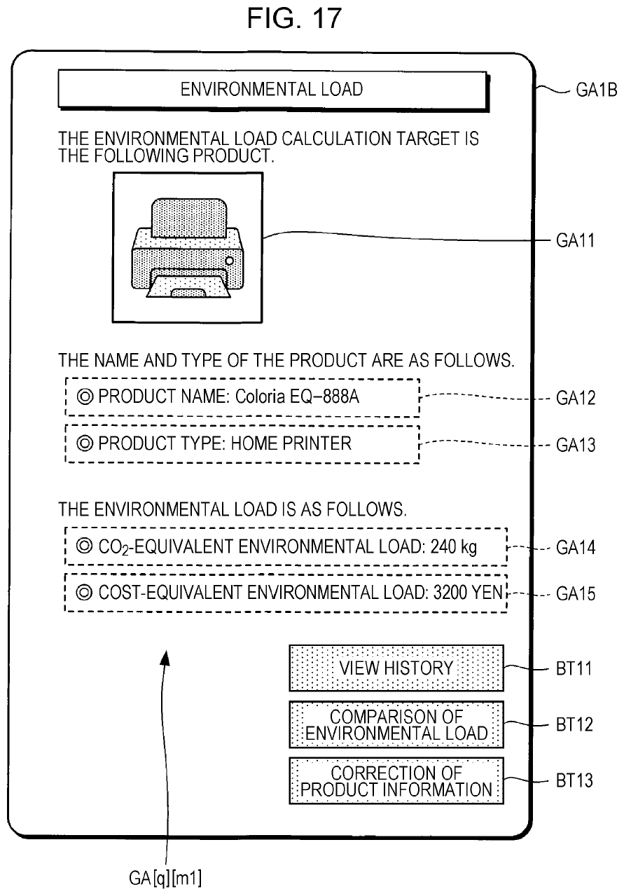

FIG. 17 is a diagram schematically illustrating an example of the environmental load presenting screen GA1B displayed on the display device 54 of the terminal device 5[q].

As illustrated in FIG. 17, the environmental load presenting screen GA1B is different from the environmental load presenting screen GA1 according to the first embodiment in that the environmental load presenting screen GA1B includes a product information correction button BT13. On the environmental load presenting screen GA1B, environmental load display information DA[q][M] is displayed in an environmental load display region GA[q][M], similarly to the environmental load presenting screen GA1. When the product name information DD1 or the product type information DD2 displayed in the environmental load display region GA[q][M] is information on a product SH different from a target product SHH whose environmental load is to be recognized by the user U[q], the user U[q] can display an input screen (not illustrated) for inputting information on the target product SHH whose environmental load is to be recognized by the user U[q] by pressing the product information correction button BT13 using the input device 55. Then, the user U[q] can input information on the target product SHH (hereinafter referred to as “user input information DU”) on the input screen.

When the user U[q] inputs the user input information DU in the terminal device 5[q], the product characteristic information generation section 121 corrects the product characteristic information DD based on the user input information DU, and the environmental load information generation section 122 executes a product identification result correction process for correcting the environmental load information DF based on the corrected product characteristic information DD.

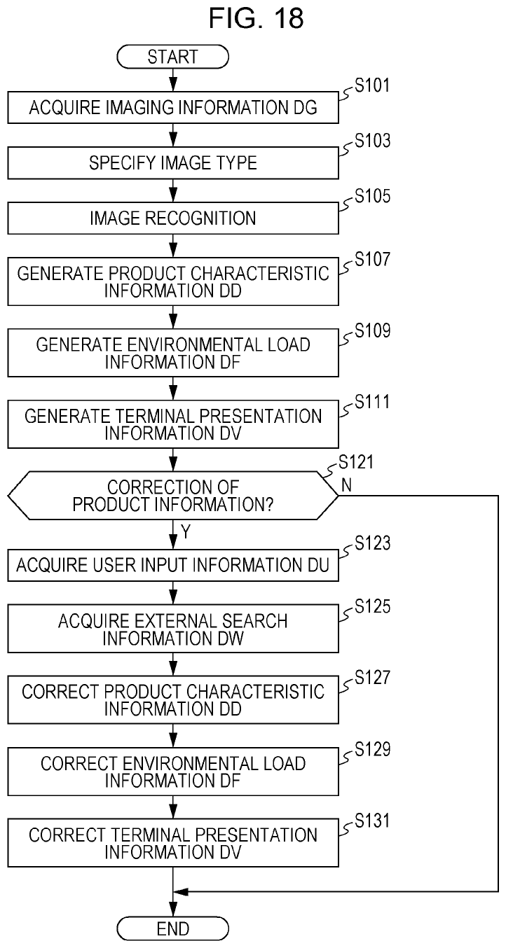

FIG. 18 is a flowchart illustrating an example of an operation of the server apparatus 1B in a case where the server apparatus 1B according to this modification performs the environmental load estimation process and the product identification result correction process.

As illustrated in FIG. 18, when the environmental load estimation process is started, the control device 10B of the server apparatus 1B executes the process from step S101 to step S111 described above.

Thereafter, the control device 10B of the server apparatus 1B executes the product identification result correction process. Specifically, the information acquisition section 11 of the server apparatus 1B determines whether the user input information DU has been input in the terminal device 5[q] and the user input information DU has been supplied to the server apparatus 1B (S121).

In a case where a result of the determination in step S121 is negative, the control device 10B terminates the environmental load estimation process and the product identification result correction process illustrated in FIG. 18.

When the result of the determination in step S121 is positive, the information acquisition section 11 of the server apparatus 1B acquires the user input information DU supplied from the terminal device 5[q] (S123).

Subsequently, the information search section 14 of the server apparatus 1B searches for information relating to the target product SHH for which the user U[q] is attempting to recognize the environmental load based on the user input information DU, and acquires external search information DW indicating a result of the search (S125).

The product characteristic information generation section 121 of the server apparatus 1B corrects the product characteristic information DD based on the user input information DU acquired in step S123 and the external search information DW acquired in step S125 by using the product characteristic learning model NT (S127).

Subsequently, the environmental load information generation section 122 of the server apparatus 1B corrects the environmental load information DF based on the product characteristic information DD corrected in step S127 using the environmental load learning model NF (S129).

The information presentation section 13 of the server apparatus 1B corrects the terminal presentation information DV based on the corrected environmental load information DF modified in step S129 (S131), transmits the corrected terminal presentation information DV to the terminal device 5[q], and then terminates the environmental load estimation process and the product identification result correction process in the flowchart of FIG. 18.

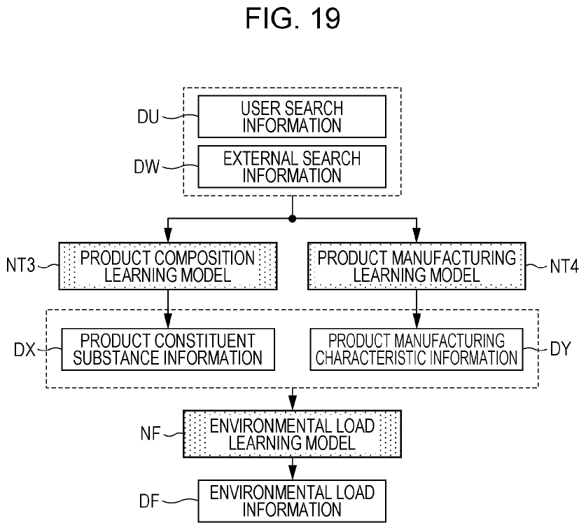

FIG. 19 is a diagram schematically illustrating an example of a data flow in the server apparatus 1B when the server apparatus 1B executes the product identification result correction process. Note that the server apparatus 1B has the same data flow as that in FIG. 11 when the server apparatus 1B executes the environmental load estimation process.

As illustrated in FIG. 19, when the product identification result correction process is started and the information acquisition section 11 acquires the user input information DU and the external search information DW, the product characteristic information generation section 121 inputs the user input information DU and the external search information DW corresponding to the target product SHH to the product composition learning model NT3 so as to acquire the product constituent substance information DX output from the product composition learning model NT3. Then, the product characteristic information generation section 121 corrects the product constituent substance information DX by changing the product constituent substance information DX generated in the environmental load estimation process to the product constituent substance information DX acquired in the product identification result correction process.

Note that, in this modification, it is assumed that the user input information DU indicates a name acquired by correcting a product name indicated by the product name information DD1, and the external search information DW indicates a product type acquired by correcting a product type indicated by the product type information DD2.

Furthermore, the product characteristic information generation section 121 acquires the product manufacturing characteristic information DY output from the product manufacturing learning model NT4 by inputting the user input information DU and the external search information DW corresponding to the target product SHH to the product manufacturing learning model NT4. Then, the product characteristic information generation section 121 corrects the product manufacturing characteristic information DY by changing the product manufacturing characteristic information DY generated in the environmental load estimation process to the product manufacturing characteristic information DY acquired in the product identification result correction process.

Subsequently, the environmental load information generation section 122 acquires the environmental load information DF output from the environmental load learning model NF by inputting the product constituent substance information DX and the product manufacturing characteristic information DY corresponding to the target product SHH to the environmental load learning model NF. Then, the environmental load information generation section 122 corrects the environmental load information DF by changing the environmental load information DF generated in the environmental load estimation process to the environmental load information DF acquired in the product identification result correction process.

As described above, according to the second embodiment, when the product name information DD1 or the product type information DD2 generated in the environmental load estimation process is information on the product SH different from the target product SHH whose environmental load is to be recognized by the user U[q], the server apparatus 1B corrects the product characteristic information DD based on the user input information DU input by the user U[q] and the external search information DW acquired from the external device. Therefore, according to the second embodiment, it is possible to reduce the risk that an environmental load of the product SH different from the target product SHH of which the user U[q] tries to recognize the environmental load is erroneously presented to the user U[q].

### B.2. Modification of Second Embodiment

This embodiment may be variously modified. Specific modifications will be described below as examples. Two or more of the modifications selected in any manner from the following examples can be appropriately combined with one another within a range in which the modifications are not inconsistent with one another.

### Modification 2.1

In the second embodiment described above, a mode in which the server apparatus 1B generates the environmental load information DF from the product characteristic information DD using the environmental load learning model NF is described as an example, but the present disclosure is not limited to this mode. The server apparatus 1B may generate the environmental load information DF from the product characteristic information DD using the environmental load database DBF that stores product constituent substance information DX and product manufacturing characteristic information DY corresponding to a product SH and the environmental load information DF corresponding to the product SH in association with each other.

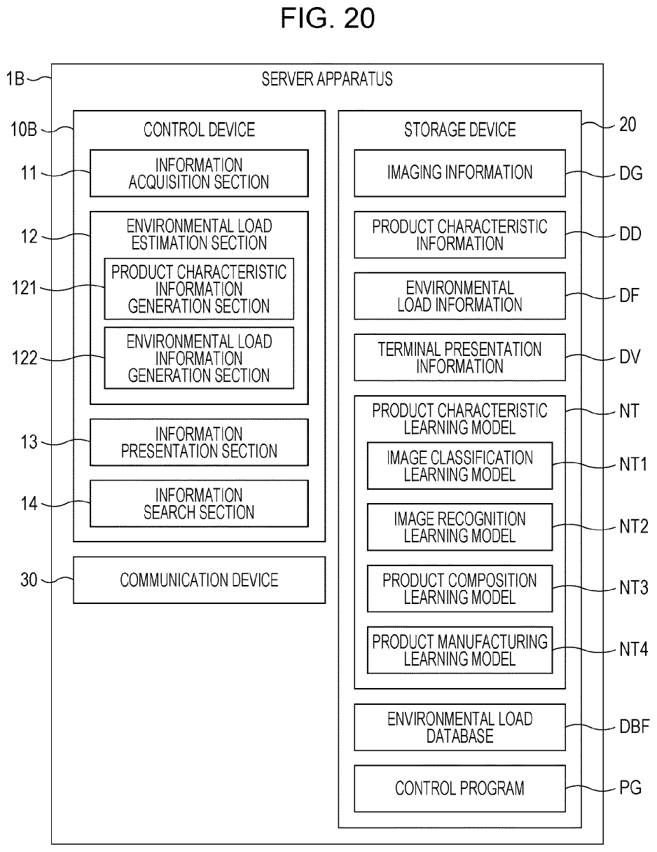

FIG. 20 is a block diagram illustrating an example of a configuration of the server apparatus 1B according to this modification.

As illustrated in FIG. 20, this modification is different from the second embodiment in that the server apparatus 1B stores the environmental load database DBF instead of the environmental load learning model NF in the storage device 20.

Note that, in the example illustrated in FIG. 20, the environmental load database DBF is stored in the storage device 20, but the present disclosure is not limited to such an aspect. The environmental load database DBF may be included in an external device installed outside the server apparatus 1B, or may be included in an external device installed outside the environmental load estimation system according to the second embodiment.

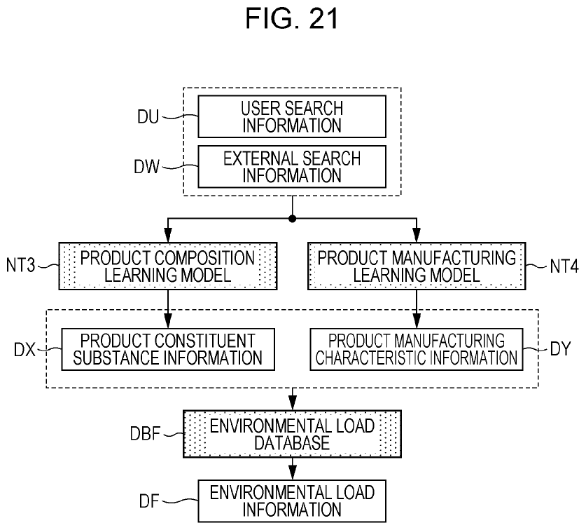

FIG. 21 is a diagram schematically illustrating an example of a data flow in the server apparatus 1B when the server apparatus 1B according to this modification executes the product identification result correction process. Note that, in this modification, the data flow is the same as that of the second embodiment illustrated in FIG. 19 except that the environmental load information DF is generated using the environmental load database DBF instead of the environmental load learning model NF.

Specifically, in the product identification result correction process according to this modification, as illustrated in FIG. 21, the environmental load information generation section 122 acquires the environmental load information DF corresponding to the product constituent substance information DX and the product manufacturing characteristic information DY from the environmental load database DBF by referring to the environmental load database DBF with the product constituent substance information DX and the product manufacturing characteristic information DY as arguments.

As described above, according to this modification, since the environmental load information DF is corrected using the environmental load database DBF, it is possible to accurately estimate an environmental load applied to an environment by the target product SHH in a case where the environmental load database DBF has information relating to the target product SHH in advance.

### Modification 2.2

In the second embodiment described above, the mode in which the server apparatus 1B corrects the environmental load information DF based on the user input information DU and the external search information DW using the product characteristic learning model NT and the environmental load learning model NF is described as an example, but the present disclosure is not limited to this mode. The server apparatus 1B may generate the environmental load information DF from the user input information DU and the external search information DW using, for example, a single learning model.

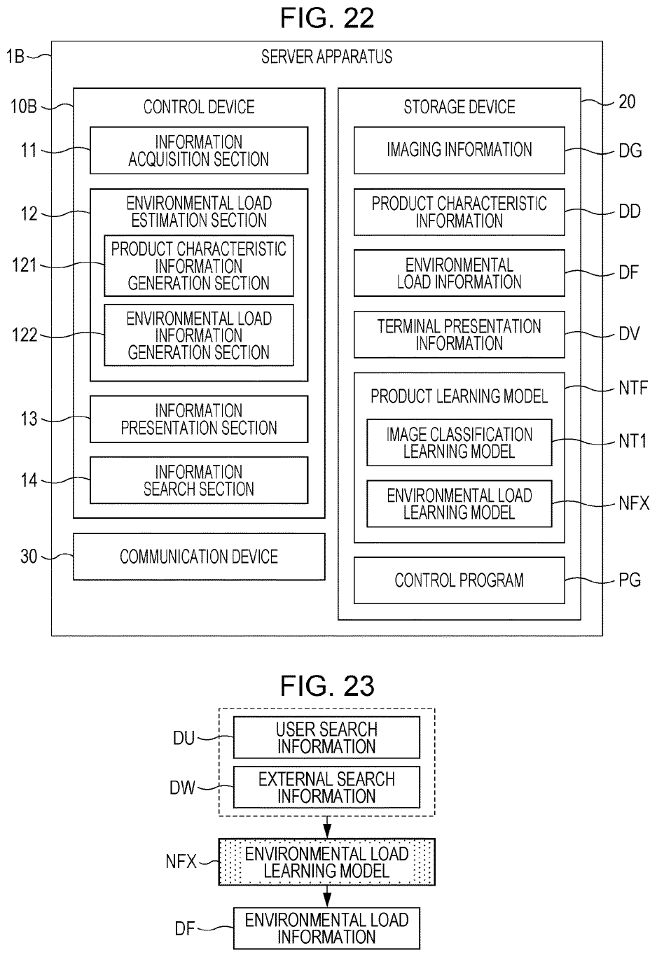

FIG. 22 is a block diagram illustrating an example of a configuration of the server apparatus 1B according to this modification.

As illustrated in FIG. 22, this modification is different from the second embodiment in that the server apparatus 1B stores the product learning model NTF in the storage device 20 instead of the product characteristic learning model NT and the environmental load learning model NF.

The product learning model NTF includes an image classification learning model NT1 and an environmental load learning model NFX.

The environmental load learning model NFX is, for example, a multilayer neural network. The environmental load learning model NFX is obtained by learning the relationship between a captured image of the product-associated object SK of the product SH, a classification item of the product-associated object SK, the user input information DU and the external search information DW corresponding to the product SH, and the environmental load information DF corresponding to the product SH by using the captured image of the product-associated object SK corresponding to the product SH and the classification item of the product-associated object SK, the user input information DU (or the product name information DD1) corresponding to the product SH and the external search information DW (or the product type information DD2) as input data and the environmental load information DF corresponding to the product SH as teacher data. Specifically, the environmental load learning model NFX outputs the environmental load information DF corresponding to the target product SHH when imaging information DG indicating a result of imaging the product-associated object SK corresponding to the target product SHH and a classification item corresponding to the imaging information DG are input. When the user input information DU (or the product name information DD1) corresponding to the target product SHH and the external search information DW (or the product type information DD2) corresponding to the target product SHH are input, the environmental load learning model NFX outputs the environmental load information DF corresponding to the target product SHH.

FIG. 23 is a diagram schematically illustrating an example of a data flow in the server apparatus 1B when the server apparatus 1B according to this modification executes the product identification result correction process.

As illustrated in FIG. 23, when the product identification result correction process is started, the user input information DU is supplied from the terminal device 5[q], and the server apparatus 1B acquires the external search information DW, the environmental load information generation section 122 inputs the user input information DU and the external search information DW to the environmental load learning model NFX to acquire a correction result of the environmental load information DF output from the environmental load learning model NFX.

In this way, in this modification, since the server apparatus 1B corrects the environmental load information DF using the environmental load learning model NFX, it is possible to correct an environmental load of the target product SHH even in a case where the storage device 20 of the server apparatus 1B does not have information relating to the target product SHH in advance.

### C. Appendices

Aspects relating to the above description are appended below. In order to facilitate understanding of each of the aspects, in the following description, reference signs in the drawings are given in parentheses for convenience, but it is not intended that the present disclosure is limited to the aspects illustrated in the drawings.

### C.1. Appendix 1

Hereinafter, an environmental load estimation system Sys according to Appendix 1 will be described.

### Appendix 1-1

An environmental load estimation system Sys (an example of an “information processing system”) according to Appendix 1-1 includes an information acquisition section 11 (an example of an “acquisition section”) that acquires imaging information DG indicating a result of imaging from a terminal device 5[q] that images a product-associated object SK (an example of an “associated object”) associated with a target product SHH, an environmental load estimation section 12 (an example of an “estimation section”) that estimates an environmental load applied to an environment by the target product SHH based on the imaging information DG, and an information presentation section 13 (an example of a “presentation section”) that presents a result of the estimation performed by the environmental load estimation section 12 on the terminal device 5[q].

According to Appendix 1-1, since the user U[q] of the terminal device 5[q] can recognize the environmental load of the target product SHH, it is possible to prompt the user U[q] who is considering purchasing the target product SHH to be conscious of environmental protection, thereby promoting environmental protection from the perspective of the user U[q].

### Appendix 1-2

In an environmental load estimation system Sys according to Appendix 1-2, in addition to the environmental load estimation system Sys according to Appendix 1-1, the environment load estimation section 12 includes a product characteristic information generation section 121 (an example of a “characteristic information generation section”) that generates product characteristic information DD (an example of “characteristic information”) relating to a characteristic of the target product SHH based on the imaging information DG, and an environmental load information generation section 122 (an example of a “load information generation section”) that generates environmental load information DF (an example of “load information”) indicating the estimation result of the environmental load applied to the environment by the target product SHH based on the product characteristic information DD.

### Appendix 1-3

In an environmental load estimation system Sys according to Appendix 1-3, in addition to the environmental load estimation system Sys according to Appendix 1-2, the product characteristic information generation section 121 generates, using a product characteristic learning model NT (an example of a “first learning model”) obtained by learning a relationship between a product-associated object SK associated with a product SH and a characteristic of the product SH, the product characteristic information DD based on the imaging information DG, and the environmental load information generation section 122 generates, using an environmental load learning model NF (an example of a “second learning model”) obtained by learning a relationship between the characteristic of the product SH and an environmental load applied to the environment by the product SH, the environmental load information DF based on the product characteristic information DD.

According to Appendix 1-3, since the environmental load applied to the environment by the target product SHH is estimated using the learning model, even if the target product SHH is a new product that is not stored in the environmental load estimation system Sys, the user U[q] can recognize the environmental load of the target product SHH.

### Appendix 1-4

In an environmental load estimation system Sys according to Appendix 1-4, in addition to the environmental load estimation system Sys according to Appendix 1-2, the product characteristic information generation section 121 generates, using a product characteristic learning model NT (an example of a “first learning model”) obtained by learning a relationship between a product-associated object SK associated with a product SH and a characteristic of the product SH, the product characteristic information DD based on the imaging information DG, and the environmental load information generation section 122 generates, using an environmental load database DBF indicating a relationship between the characteristic of the product SH and an environmental load applied to the environment by the product SH, the environmental load information DF based on the product characteristic information DD.

According to Appendix 1-4, since the environmental load applied to the environment by the target product SHH is estimated using the database, when the target product SHH is an existing product stored in the environmental load estimation system Sys, the user U[q] can accurately recognize the environmental load of the target product SHH.

### Appendix 1-5

In an environmental load estimation system Sys according to Appendix 1-5, in addition to the environmental load estimation system Sys according to Appendix 1-1, the environmental load estimation section 12 generates, using an environmental load learning model NFX (an example of a “third learning model”) obtained by learning a relationship between the product-associated object SK related to the product SH and the environmental load applied to the environment by the product SH, the environmental load information DF based on the imaging information DG.

According to Appendix 1-5, since the environmental load applied to the environment by the target product SHH is estimated using the learning model, even if the target product SHH is a new product that is not stored in the environmental load estimation system Sys, the user U[q] can recognize the environmental load of the target product SHH.

### Appendix 1-6

In an environmental load estimation system Sys according to Appendix 1-6, in addition to the environmental load estimation system Sys according to Appendices 1-1 to 1-5, the product-associated object SK is some or all of a product main body SH1 of the target product SHH, a product package SH2 (an example of an “accompanying object”) of the target product SHH, a product advertisement SH3 (an example of a “first image”) of the target product SHH, a product composition table SH4 (an example of a “second image”) indicating information on a configuration of the target product SHH, and a product manufacturing information table SH6 (an example of a “third image”) indicating information on manufacturing of the target product SHH.

According to Appendix 1-6, since the environmental load of the target product SHH can be estimated from various product-associated objects SK other than the target product SHH in addition to the product main body SH1 of the target product SHH, it is possible to increase the opportunity for the user U[q] to recognize the environmental load of the target product SHH, compared to an aspect in which the environmental load of the target product SHH is estimated based on only the product body SH1 of the target product SHH.

### Appendix 1-7

In an environmental load estimation system Sys according to Appendix 1-7, in addition to the environmental load estimation system Sys according to Appendices 1-1 to 1-6, environmental load information DF indicating the estimation result of the environmental load estimation section 12 includes some or all of emitted substance information DH (an example of “emission information”) relating to an emitted substance in a portion or all of a life cycle of the target product SHH, consumable substance information DM (an example of “consumption information”) relating to a consumable substance in a portion or all of the life cycle of the target product SHH, and energy consumption information DE (an example of “energy information”) relating to energy consumption in a portion or all of the life cycle of the target product SHH.

According to Appendix 1-7, since the user U[q] can recognize various pieces of information relating to the environmental load applied by the target product SHH, it is possible to promote the environmental awareness of the user U[q].

### Appendix 1-8

In an environmental load estimation system Sys according to Appendix 1-8, in addition to the environmental load estimation system Sys according to Appendices 1-2 to 1-4, the product characteristic information DD includes some or all of product name information DD1 (an example of “first characteristic information”) and product type information DD2 (another example of the “first characteristic information”) which indicate the characteristic of the target product SHH, product constituent substance information DX (an example of “second characteristic information”) indicating a characteristic relating to a configuration of the target product SHH, and product manufacturing characteristic information DY (an example of “third characteristic information”) indicating a characteristic relating to manufacturing of the target product SHH.

### Appendix 1-9

In an environmental load estimation system Sys according to Appendix 1-9, in addition to the environmental load estimation system Sys according to Appendices 1-1 to 1-8, when the user U[q] of the terminal device 5[q] performs an operation of indicating the product-associated object SK in the captured image GG indicating the imaging result of the product-associated object SK displayed in the display device 54 of the terminal device 5[q], the information acquisition section 11 acquires operation information indicating content of the operation and the environmental load estimation section 12 estimates an environmental load applied to the environment by the target product SHH based on the captured image GG and the operation information acquired by the information acquisition section 11.

According to Appendix 1-9, since the user U[q] can input the information on the target product SHH, it is possible to reduce the risk that the environmental load of the product SH different from the target product SHH whose environmental load is to be recognized by the user U[q] is erroneously presented to the user U[q].

### Appendix 1-10

In an environmental load estimation system Sys according to Appendix 1-10, in addition to the environmental load estimation system Sys according to Appendices 1-1 to 1-9, the information presentation section 13 presents environmental load display information DA[q][1] to environmental load display information DA[q][M] which are a history of environmental load display information DA[q][m] based on estimation results of the environmental load estimation section 12 presented on the terminal device 5[q].

According to Appendix 1-10, since the user U[q] can recognize environmental loads of the plurality of products SH, the user U[q] can determine purchase of one of the products SH in consideration of the environmental load.

### Appendix 1-11

In an environmental load estimation system Sys according to Appendix 1-11, in addition to the environmental load estimation system Sys according to Appendices 1-1 to 1-10, in a case where, after environmental load display information DA[q][m2] (an example of a “first estimation result”) obtained by the environmental load estimation section 12 estimating an environmental load applied to the environment by a certain target product SHH (an example of a “first target product”) is presented on the terminal device 5[q], environmental load display information DA[q][m 1] (an example of a “second estimation result”) obtained by the environmental load estimation section 12 estimating an environmental load applied to the environment by another target product SHH (an example of a second target product) is presented on the terminal device 5[q], an environmental load comparison screen GA2 for comparing the environmental load display information DA[q][m2] with the environmental load display information DA[q][m1] can be presented on the terminal device 5[q].

According to Appendix 1-11, since the user U[q] can recognize the environmental loads of the plurality of products SH, the user U[q] can determine the purchase of one of the products SH in consideration of the environmental loads.

### C.2. Appendix 2

Hereinafter, an environmental load estimation system Sys according to Appendix 2 will be described.

### Appendix 2-1

An environmental load estimation system Sys (an example of an “information processing system”) according to Appendix 2-1 includes an information acquisition section 11 (an example of an “acquisition section”) that acquires, from a terminal device 5[q] capturing a product-associated object SK (an example of an “associated object”) associated with a target product SHH, imaging information DG indicating a result of the imaging, a product characteristic information generation section 121 (an example of a “product identification section”) that specifies a characteristic of the target product SHH based on the imaging information DG, an environmental load information generation section 122 (an example of a “load estimation section”) that estimates an environmental load applied to an environment by the target product SHH based on a result of the specifying of the product characteristic information generation section 121, and an information presentation section 13 (an example of a “presentation section”) that presents the result of the specifying of the product characteristic information generation section 121 and a result of the estimation of the environmental load information generation section 122 on the terminal device 5[q]. When the user U[q] of the terminal device 5[q] inputs a correction of the specifying result of the product characteristic information generation section 121 to the terminal device 5[q], the information acquisition section 11 acquires user input information DU (an example of “input information”) indicating content of the input performed by the user U[q] from the terminal device 5[q]. When the information acquisition section 11 acquires the user input information DU, the product characteristic information generation section 121 corrects the result of the specifying of the characteristic of the target product SHH based on the user input information DU. When the product characteristic information generation section 121 corrects the result of the specifying of the characteristic of the target product SHH, the environmental load information generation section 122 corrects the result of the estimation of the environmental load applied to the environment by the target product SHH.

According to Appendix 2-1, since the user U[q] of the terminal device 5[q] can recognize the environmental load of the target product SHH, it is possible to prompt the user U[q] who is considering purchasing the target product SHH to be conscious of environmental protection, thereby promoting environmental protection from the perspective of the user U[q].

In addition, according to Appendix 2-1, since the result of the specifying of the characteristic of the target product SHH can be corrected based on the user input information DU, it is possible to reduce the risk that the environmental load of the product SH different from the target product SHH of which the user U[q] tries to recognize the environmental load is erroneously presented to the user U[q].

### Appendix 2-2

An environmental load estimation system Sys according to Appendix 2-2, in addition to the environmental load estimation system Sys according to Appendix 2-1, further includes an information search section 14 (an example of a “search section”) that searches an external device communicable with the environmental load estimation system Sys for external search information DW relating to the characteristic of the target product SHH based on the user input information DU when the information acquisition section 11 acquires the user input information DU. The product characteristic information generation section 121 corrects the result of the specifying of the characteristic of the target product SHH based on the external search information DW.

According to Appendix 2-2, even in a case where content of the product indicated by the user input information DU is unclear, it is possible to acquire information relating to the target product SHH from the outside, and thus it is possible to more accurately estimate the environmental load of the target product SHH.

### Appendix 2-3

In an environmental load estimation system Sys according to Appendix 2-3, in addition to the environmental load estimation system Sys according to Appendix 2-1 or Appendix 2-2, the product characteristic information generation section 121 generates, using a product characteristic learning model NT (an example of a “first learning model”) obtained by learning a relationship between a product-associated object SK associated with a product SH and a characteristic of the product SH, product characteristic information DD (an example of “characteristic information”) indicating a characteristic of the target product SHH based on the imaging information DG.

According to Appendix 2-3, since the characteristic of the target product SHH is estimated using the product characteristic learning model NT, even if the target product SHH is a new product that is not stored in the environmental load estimation system Sys, the user U[q] can recognize the environmental load of the target product SHH.

### Appendix 2-4

In an environmental load estimation system Sys according to Appendix 2-4, in addition to the environmental load estimation system Sys according to Appendices 2-1 to 2-3, the environmental load information generation section 122 generates, using an environmental load learning model NF (an example of a “second learning model”) obtained by learning a relationship between the characteristic of the product SH and the environmental load applied to the environment by the product SH, environmental load information DF (an example of “load information”) indicating a result of the estimation of the environmental load applied to the environment by the target product SHH based on the specifying result of the product characteristic information generation section 121.

According to Appendix 2-4, since the environmental load applied to the environment by the target product SHH is estimated using the learning model, even if the target product SHH is a new product that is not stored in the environmental load estimation system Sys, the user U[q] can recognize the environmental load of the target product SHH.

### Appendix 2-5

In an environmental load estimation system Sys according to Appendix 2-5, in addition to the environmental load estimation system Sys according to Appendices 2-1 to 2-3, the environmental load information generation section 122 generates, using an environmental load database DBF obtained by learning a relationship between the characteristic of the product SH and the environmental load applied to the environment by the product SH, environmental load information DF (an example of “load information”) indicating a result of the estimation of the environmental load applied to the environment by the target product SHH based on the specifying result of the product characteristic information generation section 121.

According to Appendix 2-5, since the environmental load applied to the environment by the target product SHH is estimated using the database, when the target product SHH is an existing product stored in the environmental load estimation system Sys, the user U[q] can accurately recognize the environmental load of the target product SHH.

What is claimed is:

1. An information processing system, comprising:
an acquisition section that acquires imaging information indicating a result of imaging from a terminal device that images an associated object associated with a target product;
a product identification section that specifies a characteristic of the target product based on the imaging information;
a load estimation section that estimates an environmental load applied to an environment by the target product based on a result of the specifying of the product identification section; and
a presentation section that presents the result of the specifying of the product identification section and a result of the estimation of the load estimation section on the terminal device, wherein
the acquisition section acquires,
in the terminal device, when the user of the terminal device inputs a correction of the specifying result of the product identification section,
input information indicating content of the input performed by the user from the terminal device,
the product identification section corrects,
when the acquisition section acquires the input information, the result of the specifying of the characteristic of the target product based on the input information,
the load estimation section corrects,
when the product identification section corrects the result of the specifying, the result of the estimation of the environmental load applied to the environment by the target product.

2. The information processing system according to claim 1, further comprising:
a search section that searches an external system communicable with the information processing system for information relating to the characteristic of the target product based on the input information, when the acquisition section acquires the input information, wherein
the product identification section corrects,
corrects the result of the specifying of the characteristic of the target product based on a result of the search of the search section.

3. The information processing system according to claim 1, wherein
the product identification section corrects,
using a first learning model obtained by learning a relationship between an associated object associated with a product and a characteristic of the product,
characteristic information indicating a characteristic of the target product based on the imaging information.

4. The information processing system according to claim 1, wherein
the load estimation section generates,
using a second learning model obtained by learning a relationship between the characteristic of the product and the environmental load applied to the environment by the product,
load information indicating the result of the estimation of the environmental load applied to the environment by the target product based on the specifying result of the product identification section.

5. The information processing system according to claim 1, wherein
the load estimation section generates,
using an environmental load database indicating a relationship between the characteristic of the product and the environmental load applied to the environment by the product,
load information indicating the result of the estimation of the environmental load applied to the environment by the target product based on the specifying result of the product identification section.

6. An information processing method of an information processing system, the information processing method comprising:
acquiring imaging information indicating a result of imaging from a terminal device that images an associated object associated with a target product;
specifying a characteristic of the target product based on the imaging information;
estimating an environmental load applied to an environment by the target product based on a result of the specifying; and
presenting the specifying result in the specifying and a result of the estimation in the estimating on the terminal device, wherein
the acquiring includes,
when the user of the terminal device inputs, in the terminal device, a correction of the specifying result in the specifying,
acquiring input information indicating content of the input performed by the user from the terminal device,
the specifying includes
when the input information is acquired in the acquiring,
correcting the result of the specifying of the characteristic of the target product based on the input information, and
the estimating includes
when the result of the specifying is corrected in the specifying,
correcting the result of the estimation of the environmental load applied to the environment by the target product based on the corrected result of the specifying.

7. The information processing method according to claim 6, further comprising:
searching an external system communicable with the information processing system for information relating to the characteristic of the target product based on the input information when the input information is acquired in the acquiring, wherein
the specifying includes
correcting the result of the specifying of the characteristic of the target product based on a search result acquired in the searching.

8. The information processing method according to claim 6, wherein
the specifying includes
using a first learning model obtained by learning a relationship between an associated object associated with a product and a characteristic of the product,
generating characteristic information indicating the characteristic of the target product based on the imaging information.

9. The information processing method according to claim 6, wherein
the estimating includes
using a second learning model obtained by learning a relationship between the characteristic of the product and the environmental load applied to the environment by the product,
generating load information indicating the result of the estimation of the environmental load applied to the environment by the target product based on the specifying result in the specifying.

10. The information processing method according to claim 7, wherein
the estimating includes
using an environmental load database indicating a relationship between the characteristic of the product and the environmental load applied to the environment by the product,
generating load information indicating the result of the estimation of the environmental load applied to the environment by the target product based on the specifying result in the specifying.
